(19) United States
(12) Patent Application Publication
(10) Pub. No.: US 2010/0300968 A1
(43) Pub. Date: Dec. 2, 2010

(54) MEMBRANE CLEANING WITH PULSED GAS SLUGS

(75) Inventors: Wenjun Liu, Wayne, PA (US); Edward Jordan, Lenexa, KS (US)

Correspondence Address: Siemens Corporation;U0105, Intellectual Property Department, 170 Wood Avenue South, Iselin, NJ, 08830, US

(73) Assignee: SIEMENS WATER TECHNOLOGIES CORP., Warrendale, PA (US)

(21) Appl. No.: 12/792,307

(22) Filed: Jun. 2, 2010

Related U.S. Application Data
(60) Provisional application No. 61/183,232, filed on Jun. 2, 2009.

(51) Int. Cl. B01D 65/08; B01D 63/00; B01D 65/02

(52) U.S. Cl. 210/636; 210/321.69; 210/106; 210/138

(57) ABSTRACT

Aspects and embodiments of the present application are direction to systems and methods for treating fluids and to systems and methods for cleaning membrane modules used in the treatment of fluids. Disclosed herein is a membrane filtration system and a method of operating same. The membrane filtration system comprises a plurality of membrane modules positioned in a feed tank, at least one of the membrane modules having a gas slug generator positioned below a lower header thereof, the gas slug generator configured and arranged to deliver a gas slug along surfaces of membranes within the at least one of the membrane modules and a global aeration system configured to operate independently from an aeration system providing a gas to the gas slug generator, the global aeration system configured and arranged to induce a global circulatory flow of fluid throughout the feed tank.

### RELATED APPLICATIONS

This application claims priority under 35 U.S.C. §119(e) to U.S. Provisional Application Ser. No. 61/183,232, entitled “MEMBRANE CLEANING WITH PULSED GAS SLUGS,” filed on Jun. 2, 2009, which is herein incorporated by reference in its entirety.

### FIELD OF THE DISCLOSURE

The present disclosure relates to membrane filtration systems and, more particularly, to apparatus and methods utilized to effectively clean the membranes used in such systems by scouring with gas slugs accompanied by a global aeration of feed in a feed vessel in which the membranes are immersed.

### BACKGROUND

The importance of membranes for treatment of wastewater is growing rapidly. It is now well known that membrane processes can be used as an effective tertiary treatment of sewage and provide quality effluent. However, the capital and operating cost can be prohibitive. With the arrival of submerged membrane processes where the membrane modules are immersed in a large feed tank and filtrate is collected through suction applied to the filtrate side of the membrane or through gravity feed, membrane bioreactors combining biological and physical processes in one stage promise to be more compact, efficient and economic. Due to their versatility, the size of membrane bioreactors can range from household (such as septic tank systems) to the community and large-scale sewage treatment.

The success of a membrane filtration process largely depends on employing an effective and efficient membrane cleaning method. Commonly used physical cleaning methods include backwash (backpulse, backflush) using a liquid permeate or a gas or combination thereof, membrane surface scrubbing or scouring using a gas in the form of bubbles in a liquid. Typically, in gas scouring systems, a gas is injected, usually by means of a blower, into a liquid system where a membrane module is submerged to form gas bubbles. The bubbles so formed then travel upwards to scrub the membrane surface to remove the fouling substances formed on the membrane surface. The shear force produced largely relies on the initial gas bubble velocity, bubble size and the resultant forces applied by the bubbles. To enhance the scrubbing effect, more gas may be supplied. However, this method consumes large amounts of energy. Moreover, in an environment of high concentration of solids, the gas distribution system may gradually become blocked by dehydrated solids or simply be blocked when the gas flow accidentally ceases.

Furthermore, in an environment of high concentration of solids, the solid concentration polarization near the membrane surfaces may become significant during filtration where clean filtrate passes through membranes and a higher solid-content retentate is left, leading to an increased resistance of flow of permeate through the membranes. Some of these problems have been addressed by the use of two-phase (gas-liquid) flow to clean the membranes.

Cyclic aeration systems which provide gas bubbles on a cyclic basis are claimed to reduce energy consumption while still providing sufficient gas to effectively scrub the membrane surfaces. In order to provide for such cyclic operation, such systems normally require complex valve arrangements and control devices which tend to increase initial system cost and ongoing maintenance costs of the complex valve and switching arrangements required. Cyclic frequency is also limited by mechanical valve functioning in large systems. Moreover, cyclic aeration has been found to not effectively refresh the membrane surfaces.

### SUMMARY

Aspects and embodiments disclosed herein seek to overcome or least ameliorate some of the disadvantages of the prior art or at least provide the public with a useful alternative.

According to an aspect of the present disclosure, there is provided a membrane filtration system. The membrane filtration system comprises a plurality of membrane modules positioned in a feed tank, at least one of the membrane modules having a gas slug generator positioned below a lower header thereof, the gas slug generator configured and arranged to deliver a gas slug along surfaces of membranes within the at least one of the membrane modules and a global aeration system configured to operate independently from an aeration system providing a gas to the gas slug generator, the global aeration system configured and arranged to induce a global circulatory flow of fluid throughout the feed tank.

In some embodiments the system further comprises a flow rate sensor configured to monitor a flow of permeate from the plurality of membrane modules and a controller, in communication with the flow rate sensor, configured to activate the global aeration system responsive to receiving a signal from the flow rate sensor indicative of a flow rate greater than a first amount and configured to deactivate the global aeration system responsive to receiving a signal from the flow rate sensor indicative of a flow rate less than a second amount.

In some embodiments the plurality of membrane modules are arranged in racks, and the global aeration system comprises gas diffusers configured to deliver gas between the racks of membrane modules, and in some embodiments the gas diffusers are configured to deliver gas between adjacent membrane modules in a same rack.

In some embodiments the gas diffusers are configured to deliver gas below the membrane modules.

In some embodiments the controller is configured to activate the global aeration system when the flow rate is greater than about 25 liters per square meter of filtration membrane surface area per hour, and in some embodiments the controller is configured to deactivate the global aeration system when the flow rate is less than about 25 liters per square meter of filtration membrane surface area per hour.

In some embodiments the system further comprises a transmembrane pressure sensor configured to monitor a pressure across the membranes of at least one of the membrane modules and a controller, in communication with the transmembrane pressure sensor, configured to activate the global aeration system responsive to receiving a signal from the transmembrane pressure sensor indicative of a transmembrane pressure greater than a first amount and configured to deactivate the global aeration system responsive to receiving a signal from the transmembrane pressure sensor indicative of a transmembrane pressure less than a second amount.

In some embodiments the system further comprises a feed flow rate sensor configured to monitor a flow rate of feed into the feed tank and a controller, in communication with the feed flow rate sensor, configured to activate the global aeration system responsive to receiving a signal from the feed flow rate sensor indicative of a flow rate of feed greater than a first amount and configured to deactivate the global aeration system responsive to receiving a signal from the feed flow rate sensor indicative of a flow rate of feed less than a second amount.

In some embodiments the system further comprises a timer configured to activate and deactivate the global aeration system at selected times.

According to another aspect of the present disclosure, there is provided a method of filtration. The method comprises flowing a liquid medium into a filtration vessel including a plurality of membrane modules positioned therein, each of the membrane modules including an associated gas slug generator positioned below a lower end thereof, withdrawing permeate from the plurality of membrane modules, periodically delivering gas slugs from the gas slug generators into the membrane module associated with each gas slug generator, the gas slugs passing along membrane surfaces within each of the membrane modules to dislodge fouling materials therefrom, and initiating and terminating a global circulatory flow through the filtration vessel responsive to signals derived from at least one of a permeate flow from the membrane modules, a feed flow into the filtration vessel in which the membrane modules are immersed, and a transmembrane pressure across the membranes of at least one of the membrane modules.

In some embodiments a period of time between the delivery of gas slugs into each of the plurality of membrane modules is randomly determined.

In some embodiments the method further comprises providing each gas slug generator with an essentially constant supply of gas.

In some embodiments initiating the global circulatory flow of feed comprises introducing gas into an aeration system operated independently of the gas slug generators.

In some embodiments the gas slug generators and the aeration system are supplied with gas from a common source.

In some embodiments initiating the global circulatory flow of feed further comprises initiating a pulsed flow of gas.

In some embodiments initiating the global circulatory flow of feed comprises introducing gas between adjacent membrane modules of the plurality of membrane modules.

In some embodiments the gas slugs are random in volume.

In some embodiments the timing of the release of gas slugs into a first membrane module is independent of the timing of the release of gas slugs into a second membrane module.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labelled in every drawing. In the drawings:

FIG. 1 is a simplified schematic cross-sectional elevation view of a membrane module according to one embodiment of the invention;

FIG. 2 shows the module of FIG. 1 during the pulse activation phase;

FIG. 3 shows the module of FIG. 1 following the completion of the pulsed two-phase gas/liquid flow phase;

FIG. 4 is a simplified schematic cross-sectional elevation view of a membrane module according to second embodiment of the invention;

FIG. 5 is a simplified schematic cross-sectional elevation view of an array of membrane modules of the type illustrated in the embodiment of FIG. 1;

FIG. 6 is a simplified schematic cross-sectional elevation view of another embodiment of an array of membrane modules of the type illustrated in the embodiment of FIG. 1;

FIG. 7 illustrates a computerized control system which may be utilized in one or more embodiments;

FIG. 8 is a partial cut away isometric view of an array of membrane modules of the type illustrated in the embodiment of FIG. 1;

FIG. 9 is a simplified schematic cross-sectional elevation view of a portion of the array of membrane modules of FIG. 8;

FIG. 10 is a simplified schematic cross-sectional elevation view of a water treatment system according to third embodiment of the invention;

FIGS. 11A and 11B are a simplified schematic cross-sectional elevation views of a membrane module illustrating the operation levels of liquid within the gas slug generator device;

FIG. 12 is a simplified schematic cross-sectional elevation view of a membrane module of the type shown in the embodiment of FIG. 1, illustrating sludge build up in the gas slug generator;

FIG. 13 a simplified schematic cross-sectional elevation view of a membrane module illustrating one embodiment of a sludge removal process;

FIG. 14 is a graph of the pulsed liquid flow pattern and air flow rate supplied over time in accordance with one example;

FIG. 15 is a graph of membrane permeability over time comparing cleaning efficiency using a gaslift device and a gas slug generator device according to an embodiment disclosed herein;

FIG. 16 shows a schematic representation of the various forms of gas flow within a tube;

FIGS. 17A and 17B show a side elevation representation of a gas slug moving through a tube;

FIG. 18 shows an isometric schematic view of the test membrane module used in the examples to demonstrate the characteristics of slug flow;

FIG. 19 shows a graph of bubble diameter versus height within the test module of FIG. 18;

FIG. 20 is an elevational photograph of a gas slug moving through the membrane fibres in the test device of FIG. 18;

FIGS. 21A and 21B show test device of FIG. 18 and a plane 20 mm from the glass wall of the test module onto which experimental and numerical results at three different height (Y) locations were compared;

FIGS. 22A to 22C show graphs of water velocity over time for simulation and experimental values in a slug flow example;

FIGS. 23A to 23C show graphs of the air bubble size distribution at different levels within a test device of FIG. 18 during a pulse of the gas/liquid flow;

FIGS. 24A to 24C show graphs of the air bubble size versus time at different levels within a test device of FIG. 18 during a pulse of the gas/liquid flow;

FIG. 25 shows a graph of the air flow rate versus the average time span of each pulse of gas liquid flow in the device of FIG. 18; and

FIG. 26 shows a graph of inlet water rate to the gas lift device over time with camera frames during a period of observation.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” “having,” “containing,” “involving,” and variations thereof herein is meant to encompass the items listed thereafter and equivalents thereof as well as additional items.

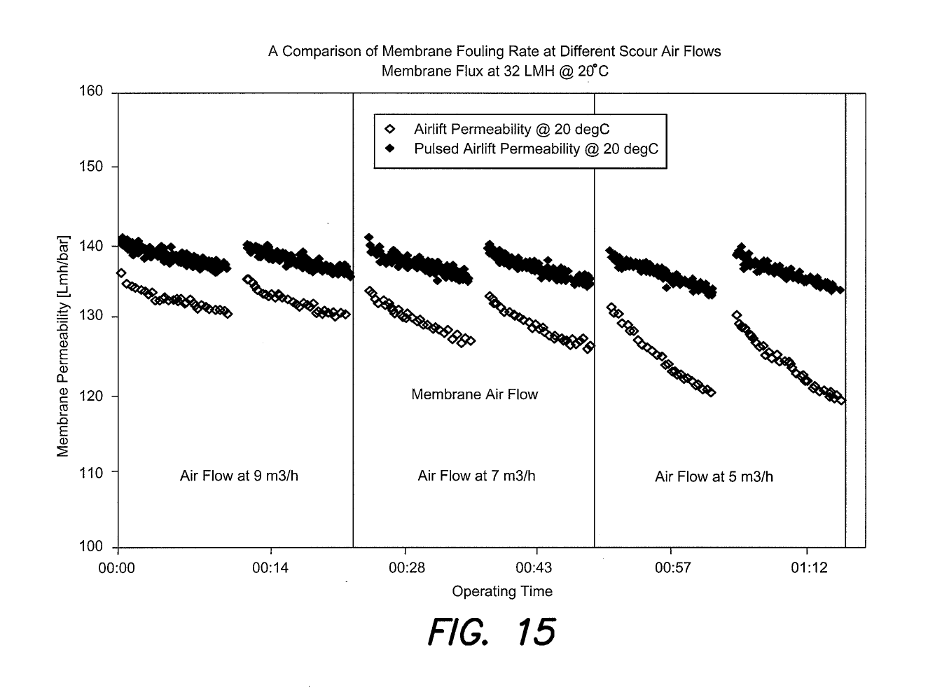

In accordance with various aspects and embodiments disclosed herein there is provided a method of filtering a liquid medium within a feed tank or vessel. The liquid medium may include, for example, water, wastewater, solvents, industrial runoff, fluids to be prepared for human consumption, or forms of liquid waste streams including components which are desired to be separated. Various aspects and embodiments disclosed herein include apparatus and methods for cleaning membrane modules immersed in a liquid medium. In some aspects, the membrane modules are provided with a randomly generated intermittent or pulsed fluid flow comprising slugs of gas passing along surfaces of membranes within the membrane modules to dislodge fouling materials therefrom and reduce the solid concentration polarisation. What is meant by “gas slug flow,” as well as other types of two-phase gas liquid flow, is illustrated in FIG. 16. In conjunction with the provision of the gas slugs to scour the membrane modules, there is provided a global aeration system configured to induce a global circulation of feed liquid throughout the feed tank.

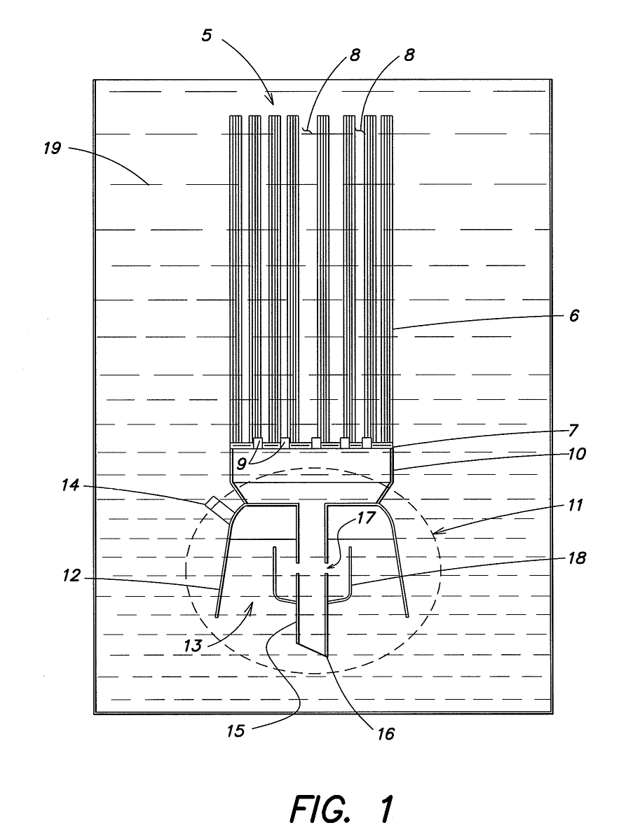

Referring to the drawings, FIGS. 1-3 show a membrane module arrangement according to one embodiment.

The membrane module 5 includes a plurality of permeable hollow fiber membrane bundles 6 mounted in and extending from a lower potting head 7. In this embodiment, the bundles are partitioned to provide spaces 8 between the bundles 6. It will be appreciated that any desirable arrangement of membranes within the module 5 may be used. A number of openings 9 are provided in the lower potting head 7 to allow flow of fluids therethrough from the distribution chamber 10 positioned below the lower potting head 7.

A gas slug generator device 11 is provided below the distribution chamber 10 and in fluid communication therewith. The gas slug generator device 11 includes an inverted gas collection chamber 12 open at its lower end 13 and a gas inlet port 14 adjacent its upper end. A central riser tube 15 extends through the gas collection chamber 12 and is fluidly connected to the base of distribution chamber 10 and open at its lower end 16. The riser tube 15 is provided with an opening or openings 17 partway along its length. A tubular trough 18 extends around and upward from the riser tube 15 at a location below the openings 17. In some embodiments, a gas slug generator device is not provided for each membrane module, and in other embodiments multiple membrane modules are supplies with gas slugs from a same gas slug generator device.

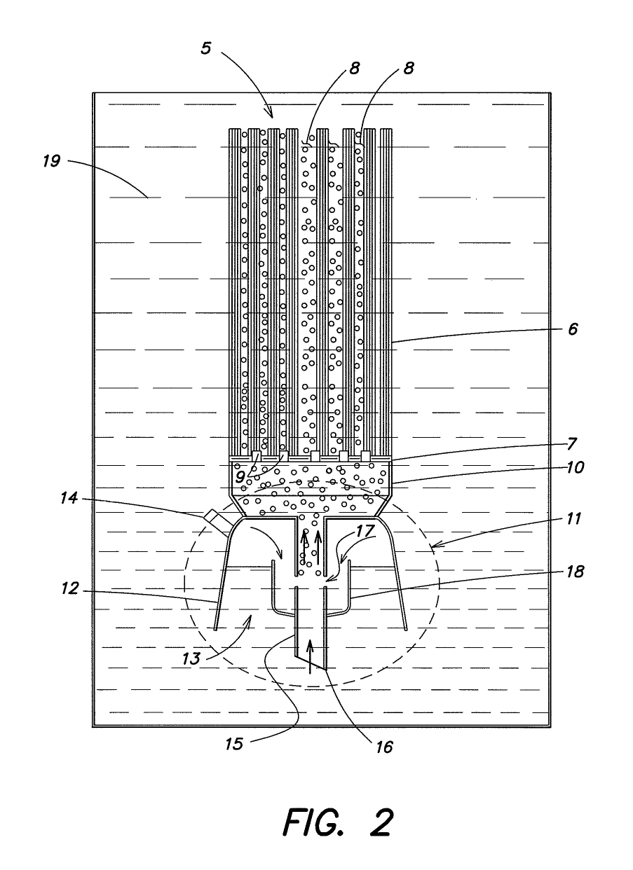

In use, the module 5 is immersed in liquid feed 19 and a source of pressurized gas is applied, essentially continuously, to gas inlet port 14. As used herein, “essentially continuously” or an “essentially constant” flow means a flow which is continuous while the module is in operation except for possible occasional momentary disruptions or reductions in the flow rate. The gas gradually displaces the feed liquid 19 within the inverted gas collection chamber 12 until it reaches the level of the opening 17. At this point, as shown in FIG. 2, the gas breaks the liquid seal across the opening 17 and surges through the opening 17 and upward through the central riser tube 15 creating a gas slug which flows through the distribution chamber 10 and into the base of the membrane module 5. In some embodiments the rapid surge of gas also sucks liquid through the base opening 16 of the riser tube 15 resulting in a high velocity two-phase gas/liquid flow. The gas slug and/or two-phase gas/liquid pulse then flows through the openings 9 to scour the surfaces of the membranes 6. The trough 18 prevents immediate resealing of the opening 17 and allows for a continuing flow of the gas/liquid mixture for a short period after the initial pulse.

In accordance with some embodiments the initial surge of gas provides two phases of liquid transfer, ejection and suction. The ejection phase occurs when the gas slug is initially released into the riser tube 15, creating a strong buoyancy force which ejects gas and liquid rapidly through the riser tube 15 and subsequently through the membrane module 5 to produce an effective cleaning action on the membrane surfaces. The ejection phase is followed by a suction or siphon phase where the rapid flow of gas out of the riser tube 15 creates a temporary reduction in pressure due to density difference which results in liquid being sucked through the bottom 16 of the riser tube 15. Accordingly, the initial rapid two-phase gas/liquid flow is followed by reduced liquid flow which may also draw in further gas through opening 17. In other embodiments, a gas slug is produced without an accompanying suction or siphon phase.

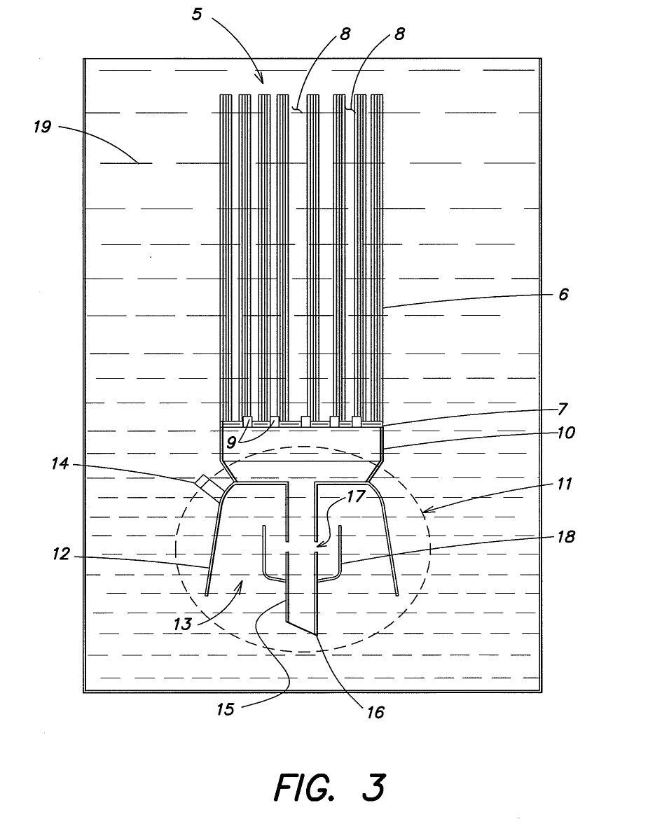

The gas collection chamber 12 then refills with feed liquid, as shown in FIG. 3, and the process begins again resulting in another pulsing of gas slug or two-phase gas/liquid cleaning of the membranes 6 within the module 5. Due to the relatively uncontrolled nature of the process, the pulses are generally random in frequency and duration.

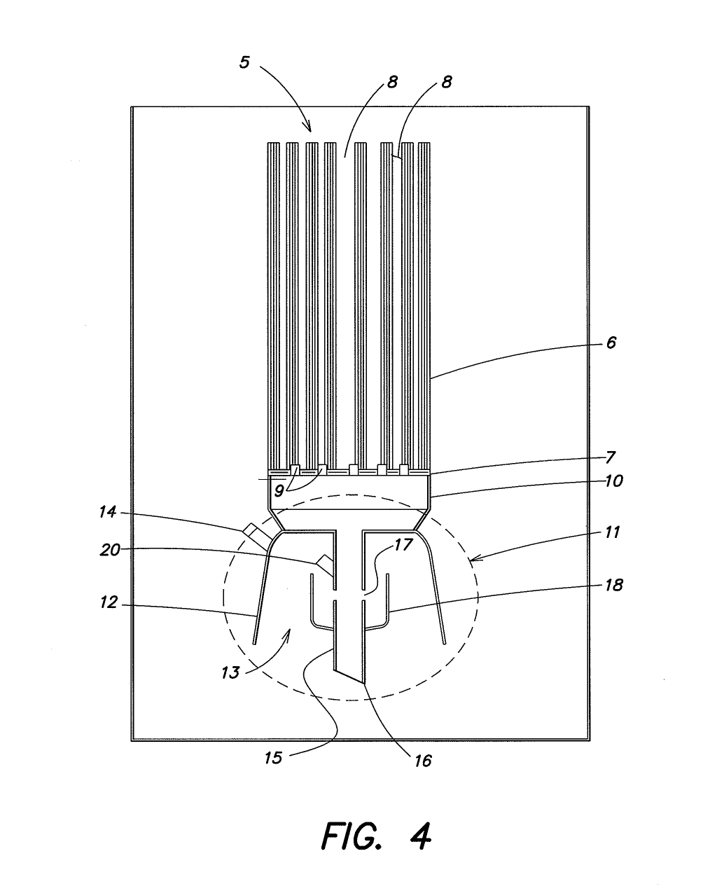

FIG. 4 shows a further modification of the embodiment of FIGS. 1-3. In this embodiment, a hybrid arrangement is provided where, in addition to the pulsed gas slug or pulsed two-phase gas/liquid flow, a steady state supply of gas is fed to the upper or lower portion of the riser tube 15 at port 20 to generate a constant gas/liquid flow through the module 5 supplemented by the intermittent pulsed gas slug or two-phase gas/liquid flow.

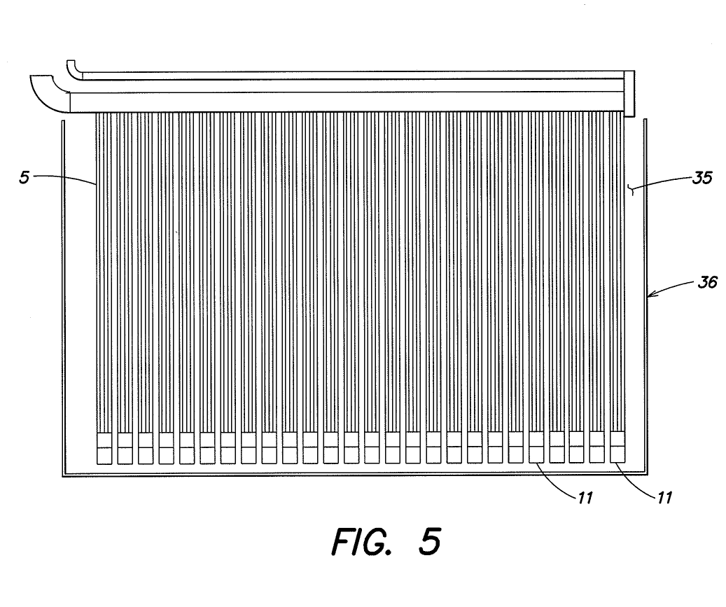

FIG. 5 shows an array of modules 35 and gas slug generator devices 11 of the type described in relation to the embodiment of FIGS. 1-3. The modules 5 are positioned in a feed tank 36. In operation, the pulses of gas bubbles produced by each gas slug generator 11 occur randomly for each module 5 resulting in an overall random distribution of pulsed gas bubble generation within the feed tank 36. This produces a constant but randomly or chaotically varying agitation of liquid feed within the feed tank 36. The series of gas slugs released by each gas slug generator device is described herein as occurring periodically. The terms “periodically” produced gas pulses or “periodically” released gas pulses as used herein are not limited to meaning the production or release of gas pulses at a constant rate. A “periodic” production or release also may encompass production or release events which occur at random time intervals.

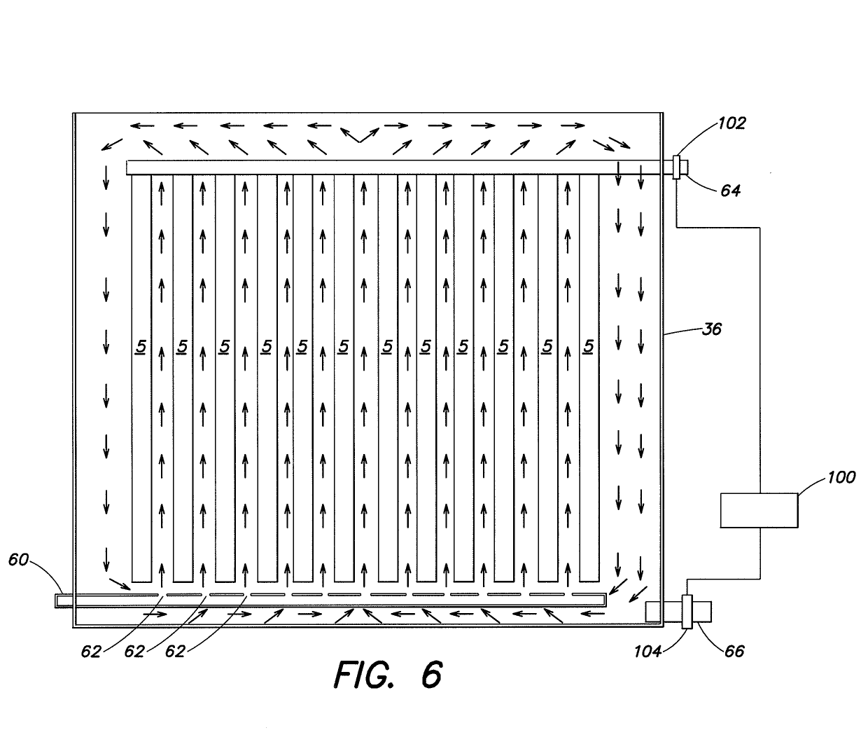

It has been observed that the overall random distribution of pulsed gas bubble generation within the feed tank 36 will in some embodiments disrupt a global circulation of feed liquid through the feed tank 36. The disruption of the global circulation of feed liquid may be especially pronounced in embodiments where the pulsed gas bubbles are in the form of gas slugs. In some embodiments, it is preferable that feed circulate through the feed tank in an upwards direction through the array of membrane modules 35 and then downward around the array of membrane modules proximate the walls of the feed tank. This global circulatory flow is illustrated by the arrows in FIG. 6. It should be noted that FIG. 6 is a partial cross section of an embodiment of a membrane filtration apparatus and that the flow of feed would in actuality circulate downward along the walls illustrated as well as other walls which are not represented in this cross sectional illustration. In some embodiments, it is desirable to maintain this global circulatory feed flow such that particulates and/or other contaminants within the feed become more evenly distributed throughout the feed tank than would occur without this circulatory flow. In other embodiments it is desirable to increase the velocity of an existing circulatory feed flow to facilitate better distribution of particulates and/or other contaminants within the feed tank. In some embodiments the global circulatory feed flow facilitates the removal of particles and/or other contaminants from the vicinity of the membrane fiber surfaces. In some embodiments, maintaining the global circulatory feed flow becomes more important as the membrane filtration system operates at higher rates of permeate flux. At higher operating rates (higher rates of permeate flux) particles may tend to build up more quickly in the vicinity of the membrane fiber surfaces than at lower operating rates, thus making it more desirable for a mechanism such as the global circulatory feed flow to operate to remove and/or redistribute these particles.

As illustrated in FIG. 6, in some embodiments, a gas diffuser, such as an aeration tube 60 having multiple aeration openings 62 may be provided in a feed tank 36 below an array of membrane modules 5. As illustrated in FIG. 6, the aeration openings are provided below and between adjacent membrane modules in the rack of membrane modules illustrated. In alternate embodiments the aeration openings may be provided on a lower side of the aeration tube 60, rather than on an upper side, as illustrated in FIG. 6. Further, in alternate embodiments, the aeration tube need not be located beneath the membrane modules, but could be located above a lower extremity of the membrane modules. It should be noted that in FIG. 6 only one rack of membrane modules 5 is illustrated, however in some embodiments, a plurality of racks of membrane modules 5, for example, 20 racks of 16 modules each, with an aeration tube 60 between each pair of racks, may make up a membrane module array 35 utilized to filter feed from a feed tank 36.

A gas, such as air, may be provided to the aeration tube 60 from an external source such as a blower or a pressurized tank (not shown). The source of gas for the aeration tube 60 may be the same as the source of gas for the gas slug generator devices 11. In some embodiments, valves and/or flow controllers (not shown) are utilized to provide gas to the aeration tube 60 when needed, while maintaining a constant or essentially constant flow of gas to the gas slug generator devices 11. In other embodiments, the aeration tube 60 and the gas slug generator devices 11 are supplied with different gasses and/or gas from different sources. In some embodiments, the aeration tube 60 is supplied with a constant flow of gas to produce bubbles which flow upward around and/or through the membrane modules 5 and induce or increase the flow velocity of a global circulatory flow of feed through the feed tank 36 indicated by the arrows in FIG. 6. In other embodiments, the flow of gas to the aeration tube 60 is pulsed when aeration to the aeration tube 60 is activated. In some embodiments, the gas flow to the aeration tube 60 may be turned on for 30 minutes and off for 30 minutes, and in some embodiments, this gas flow pulsation may be performed at a higher frequency, for example, up to a frequency of one minute on and one minute off. The on and off times for the gas supply to the aeration tube need not be the same.

In other embodiments, where it is desired that the aeration tube 60 supply the aeration gas only during periods of high operating rates, a flow rate sensor 102 may be provided on a permeate withdrawal outlet 64 to measure the flow of permeate being withdrawn from the filtration modules. The flow rate sensor 102 may comprise a paddle wheel type sensor positioned in the filtrate removal tube 64, a magnetic flow sensor, an optical flow sensor, or any other form of fluid flow sensor known in the art. A controller 100 coupled to the flow rate sensor 102 may be configured to cause gas to be supplied to the aeration tube 60 only during periods when the permeate flow exceeds a first or predetermined threshold level. In other embodiments, the controller 100 would be configured to activate the global aeration system (cause gas to be supplied to the aeration tube 60) after a defined amount of permeate had been withdrawn from the system subsequent to a previous global aeration cycle. In some embodiments, the controller 100 may cause the supply of gas to the aeration tube 60 to be pulsed when the delivery of gas to the aeration tube 60 is activated, as is described above.

In other embodiments, a flow sensor 104 which measures flow of feed in a feed inlet tube 66 may be used in addition to, or as alternative to flow sensor 102 to determine when to activate a gas supply to the aeration tube 60. During periods of higher than normal feed input to the feed tank, the controller 100 may be configured to activate the flow of gas to the aeration tube when the flow sensor 104 indicates a flow of feed exceeding a first or particular threshold level. In a similar manner, the controller 100 may terminate a flow of gas to the aeration tube 60 responsive to receiving a signal from one or both of sensors 102 and/or 104 indicating that a flow rate of permeate and/or feed has dropped below a second or predetermined level.

In some embodiments, such as in a municipal wastewater treatment facility, the flow of feed may vary by time of day. For example, during times of low wastewater production, such as during the late night and early morning, feed may flow into the feed tank 36 at a low rate. During times of high wastewater production, such as during the late morning hours or the early evening, feed may flow into the feed tank 36 at a higher rate. A filtration system may be controlled accordingly. For example, a timer may be used to activate and/or deactivate the delivery of gas to the aeration tube(s) 60 at specified times. These times could vary between weekdays and days of the weekend and/or holidays. In other embodiments a timer may be utilized to activate the delivery of gas to the aeration tube(s) 60 after a defined period of time had passed after a previous activation of the global aeration system. In further embodiments, a timer may be utilized to activate the delivery of gas to the aeration tube(s) 60 after a defined period of time had passed after another event had occurred, such as a membrane cleaning or backwash cycle, or after a defined number of backwash cycles or other events had occurred. In even further embodiments the timer could be coupled to an intelligent control system, for example, one utilizing artificial intelligence that, during a learning period, would monitor under what conditions (including, for example, permeate flow, feed flow rate, transmembrane pressure, and/or time of day) the global aeration system was activated and/or deactivated. Upon completion of the learning period, the controller and/or timer would then autonomously activate and/or deactivate the global aeration system responsive to the detection of conditions under which it had learned were appropriate.

In some embodiments a “normal” permeate flux rate may be defined as about 25 liters per square meter of filtration membrane area per hour (lmh). In some embodiments gas may be supplied to the aeration tube 60 when the flux exceeds this “normal” rate. In some embodiments a threshold permeate flux level for activating a gas supply to the aeration tube 60 may be set at about 30 lmh. In other embodiments, this threshold level may be set higher, such as at 40 lmh. In some embodiments similar flow rates of feed into the feed tank (for example, 25 lmh, 30 lmh, or 40 lmh) may be used as threshold levels for activating a flow of gas to the aeration tube 60. In some embodiments, the flow of gas to the aeration tube 60 may be suspended when the permeate flux rate returns to “normal.” In other embodiments, the flow of gas to the aeration tube 60 may be suspended when the permeate flow rate and/or the feed supply rate drops by a defined level below the activation threshold level. For example, in some embodiments, the flow of gas to the aeration tube 60 may be suspended when the permeate flux rate drops by more than 5 lmh, or the feed supply rate, from the flow rate at which the gas supply was activated; or, in other embodiments, when the permeate flux drops by more than 10 lmh below the activation threshold level. In other embodiments, gas may be supplied to the aeration tube 60 when one or both of permeate or feed flow increased by more than a specified percentage over a baseline level (such as the “normal” level.) For example, the global aeration system could be activated when one or both of permeate or feed flow increased by more than 25%, or in other embodiments, more than 50% from a baseline level. The global aeration system would be deactivated when one or both of the permeate or feed flow returned to the baseline level, or in other embodiments, returned to a specified percentage, for example 5% or 10% above the baseline level. Different set points could be set depending on, for example, the size of the filtration system, the type of fluid being treated, or based on calculations of the energy trade off between supplying the gas to the aeration tube(s) 60 and the expected increase in the requirements for, for example, backwashing of the membrane modules while operating under increased permeate and/or feed flow rate conditions.

In other embodiments, other parameters, such as transmembrane pressure may be utilized to trigger the initiation or cessation of flow of gas to the aeration tube 60. Over time as filtration of feed progresses, an increase in concentration of particles may build up around the filtration modules. This build up of particles may block portions of the membranes in the membrane modules, thus increasing the transmembrane pressure required to obtain a specified amount of permeate flow. In some embodiments, one or more transmembrane pressure sensors are configured to monitor the transmembrane pressure of one or more of the membrane fibers in one or more of the membrane modules and provide a signal to the controller 100 when the transmembrane pressure exceeds a defined set point. Responsive to this signal from the transmembrane pressure sensor(s) the controller initiates gas flow to the aeration tube 60. Gas flow from the aeration tube 60 induces or increases global circulation of feed through the vessel, removing or redistributing particles from around the membrane modules, thereby reducing the observed transmembrane pressure. The desired set points for initiating or suspending air flow to the aeration tube 60 could be set at absolute levels or at relative levels, for example, at levels defined as a percentage above the transmembrane pressure observed during filtration after a membrane cleaning and/or backwashing cycle (a baseline level). For example, the set point for initiating the flow of gas to the aeration tube 60 would in one embodiment be set at about 20% above the baseline level, and in other embodiments, this set point would be set at a higher level, for example about 50% above the baseline level. In one example, the gas flow to the aeration tube 60 would be suspended when the transmembrane pressure returned to about 10% above the baseline level, and in another example, when the transmembrane pressure returned to about 25% above the baseline level. In other embodiments, other set points for initiating or suspending air flow to the aeration tube 60 could be used depending on, for example, an examination of the trade off in energy costs between providing the gas flow to the aeration tube 60 versus the costs associated with providing sufficient suction or pressure to enable efficient operation with a particular level of transmembrane pressure.

In some embodiments, gas supplied from the aeration tube 60 does not penetrate the membrane modules or contact the membrane fibers therein. This may occur because the gas supplied from the aeration tube 60 experiences less flow resistance when flowing upward in spaces between the membrane modules than when flowing through the modules. In some embodiments the gas supplied from the aeration tube 60 is utilized solely to induce or enhance a global circulatory flow of feed through the feed tank 36. This may especially be true in embodiments wherein the membrane fibers are enclosed at least partially or fully within a tube in the membrane modules. In other embodiments, gas supplied from the aeration tube 60 does contact the surfaces of the membrane fibers in the membrane modules, and provides energy in addition to that provided by the gas slugs from the gas slug generator devices 11 for scrubbing the membrane fiber surfaces.

The amount of gas supplied to the aeration tube(s) 60 (when activated) may in some embodiments be comparable to the flow of gas supplied to the gas slug generator devices 11. In other embodiments, the flow of gas to the aeration tube(s) 60, when activated, may exceed, or in other embodiments, be less than a flow of gas to the gas slug generator devices. For example, in one embodiment, a flow of gas to the gas slug generator devices 11 may be about four cubic meters per hour per module and a flow of gas to the aeration system including the aeration tube or tubes 60, when activated, may be about three cubic meters per hour per module.

In some embodiments, an amount of energy utilized by a filtration system utilizing both gas slug generator devices 11 and aeration tubes 60 may be less than an amount of energy utilized by an equivalent filtration system producing a same amount of permeate, but operating with the gas slug generator devices 11 in the absence of the aeration tubes 60. The aeration tubes may, as described above, enhance global circulation of feed through the filtration tank, removing high concentrations of particles from the vicinity of the membrane modules. Thus, less gas would need to be supplied by the gas slug generator devices to provide an equivalent amount of particle removal from the membranes in systems including the aeration tubes 60 than in systems without the aeration tubes 60. In some embodiments including the aeration tubes 60, the amount of gas required to be supplied to the gas slug generator devices 11 to achieve an equivalent of membrane cleaning as in systems without the aeration tubes 60 could be reduced by approximately 25%. For example, the addition of the aeration tubes 60 to a system operating with the gas slug generator devices 11 could enable the gas supplied to the gas slug generator devices to be reduced from about four cubic meters per hour per module to about three cubic meters per hour per module and achieve the same amount of membrane cleaning.

To provide for initiating and suspending flow of gas to the aeration tubes 60, in different embodiments, the controller 100 may monitor parameters from various sensors within the membrane filtration system. The controller 100 may be embodied in any of numerous forms. The monitoring computer or controller may receive feedback from sensors such as sensors 102 and 104 and in some embodiments, additional sensors, such as pressure, trans-membrane pressure, temperature, pH, chemical concentration, or liquid level sensors in the feed tank 36, the gas slug generator devices 11, or in the feed supply piping, permeate piping or other piping associated with the filtration system. In some embodiments the monitoring computer or controller 100 produces an output for an operator, and in other embodiments, automatically adjusts processing parameters for the filtration system, based on the feedback from these sensors. For example, a rate of flow of gas to one or more membrane modules 5, one or more gas slug generator 11, and/or one or more aeration tubes 60 may be adjusted by the controller 100.

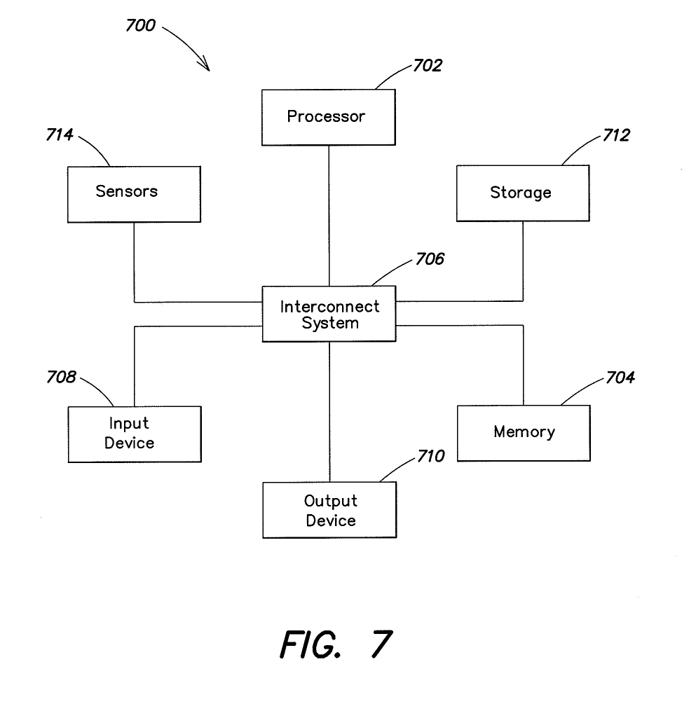

In one example, a computerized controller 100 for embodiments of the system disclosed herein is implemented using one or more computer systems 700 as exemplarily shown in FIG. 7. Computer system 700 may be, for example, a general-purpose computer such as those based on an Intel PENTIUM® or Core™ processor, a Motorola PowerPC® processor, a Sun UltraSPARC® processor, a Hewlett-Packard PA-RISC® processor, or any other type of processor or combinations thereof. Alternatively, the computer system may include specially-programmed, special-purpose hardware, for example, an application-specific integrated circuit (ASIC) or controllers intended specifically for wastewater processing equipment.

Computer system 700 can include one or more processors 702 typically connected to one or more memory devices 704, which can comprise, for example, any one or more of a disk drive memory, a flash memory device, a RAM memory device, or other device for storing data. Memory 704 is typically used for storing programs and data during operation of the controller and/or computer system 700. For example, memory 704 may be used for storing historical data relating to measured parameters from any of various sensors over a period of time, as well as current sensor measurement data. Software, including programming code that implements embodiments of the invention, can be stored on a computer readable and/or writeable nonvolatile recording medium such as a hard drive or a flash memory, and then copied into memory 704 wherein it can then be executed by processor 702. Such programming code may be written in any of a plurality of programming languages, for example, Java, Visual Basic, C, C#, or C++, Fortran, Pascal, Eiffel, Basic, COBAL, or any of a variety of combinations thereof.

Components of computer system 700 may be coupled by an interconnection mechanism 706, which may include one or more busses (e.g., between components that are integrated within a same device) and/or a network (e.g., between components that reside on separate discrete devices). The interconnection mechanism typically enables communications (for example, data and/or instructions) to be exchanged between components of system 700.

The computer system 700 can also include one or more input devices 708, for example, a keyboard, mouse, trackball, microphone, touch screen, and one or more output devices 710, for example, a printing device, display screen, or speaker. The computer system 700 may be linked, electronically or otherwise, to one or more sensors 714, which, as discussed above, may comprise, for example, sensors such as flux, flow rate, pressure, temperature, pH, chemical concentration, or liquid level sensors in any one or more portions of the embodiments of the filtration system described herein. In addition, computer system 700 may contain one or more interfaces (not shown) that can connect computer system 700 to a communication network (in addition or as an alternative to the network that may be formed by one or more of the components of system 700). This communications network, in some embodiments, forms a portion of a process control system for the filtration system.

According to one or more embodiments, the one or more output devices 710 are coupled to another computer system or component so as to communicate with computer system 700 over a communication network. Such a configuration permits one sensor to be located at a significant distance from another sensor or allow any sensor to be located at a significant distance from any subsystem and/or the controller, while still providing data therebetween.

Although the computer system 700 is shown by way of example as one type of computer system upon which various aspects of the invention may be practiced, it should be appreciated that the various embodiments of the invention are not limited to being implemented in software, or on the computer system as exemplarily shown. Indeed, rather than implemented on, for example, a general purpose computer system, the controller, or components or subsections thereof, may alternatively be implemented as a dedicated system or as a dedicated programmable logic controller (PLC) or in a distributed control system. Further, it should be appreciated that one or more features or aspects of the control system may be implemented in software, hardware or firmware, or any combination thereof. For example, one or more segments of an algorithm executable on the computer system 700 can be performed in separate computers, which in turn, can be in communication through one or more networks.

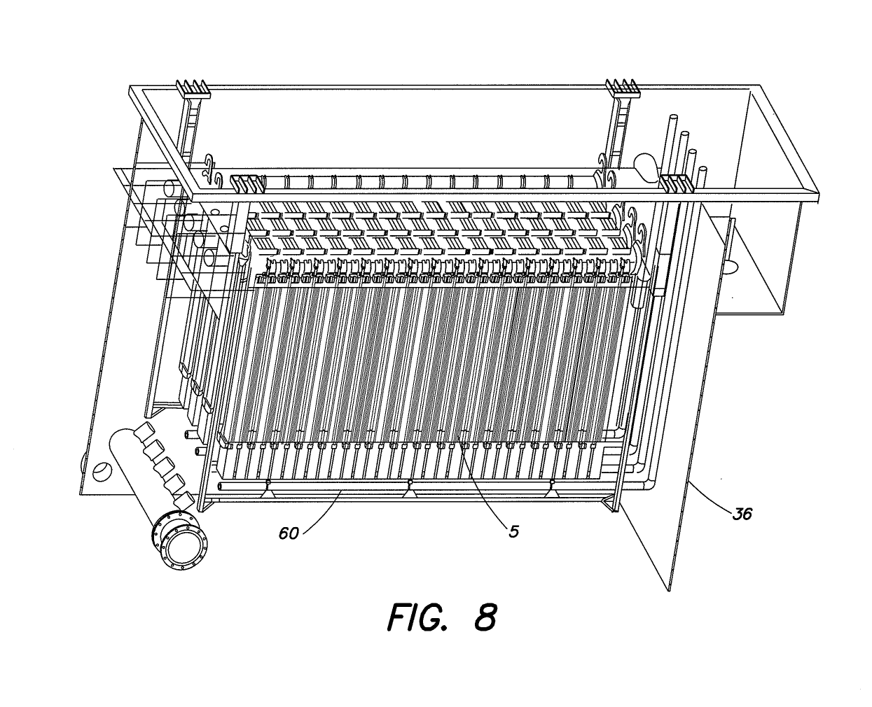

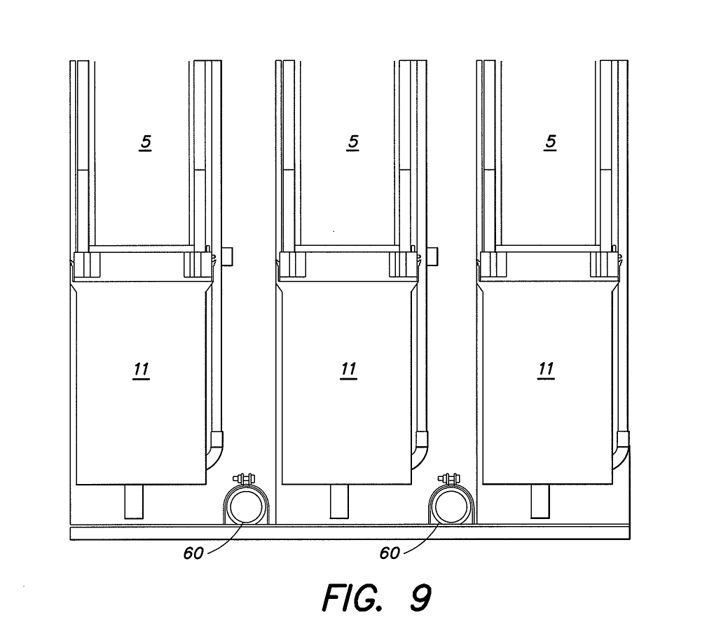

FIGS. 8 and 9 illustrate another embodiment of a membrane filtration system according to the present disclosure. FIG. 8 is an isometric view of a bank of membrane modules including multiple racks of membrane modules 5 mounted in a feed tank 36. Walls of the feed tank are cut away to show the bank of membrane modules. FIG. 9 illustrates a cross section of a portion of the membrane module bank of FIG. 8 perpendicular to the axis of the aeration tubes 60. In these FIGS. it can be seen that the aeration tubes 60 are located substantially centered below and between adjacent membrane module racks within the bank of membrane modules. In some embodiments, aeration tubes 60 are also provided between outside membrane module racks (membrane module racks closest to walls of the feed tank) and the walls of the feed tank such that the outside membrane racks have aeration tubes 60 on both sides of the lengthwise axis of the membrane module rack.

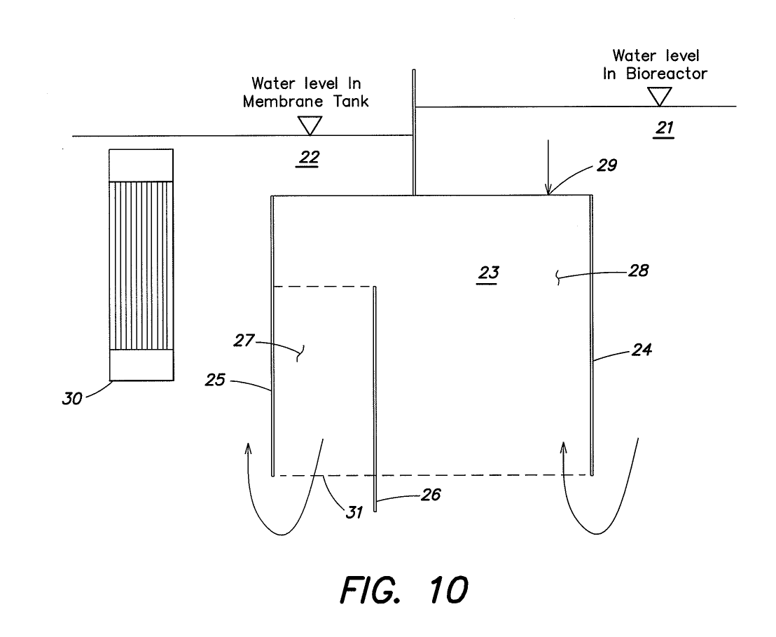

FIG. 10 shows an arrangement for use of the invention in a water treatment system using a membrane bioreactor. In this embodiment a pulsed gas slug or pulsed two-phase gas/liquid flow is provided between a bioreactor tank 21 and membrane tank 22. The tanks are coupled by an inverted gas collection chamber 23 having one vertically extending wall 24 positioned in the bioreactor tank 21 and a second vertically extending wall 25 positioned in the membrane tank 22. Wall 24 extends to a lower depth below the level of the liquid within the bioreactor tank 21 than does wall 25 below the level of the liquid within the membrane tank 22. The gas collection chamber 23 is partitioned by a connecting wall 26 between the bioreactor tank 21 and the membrane tank 22 to define two compartments 27 and 28. Gas, typically air, is provided to the gas collection chamber 23 through port 29. A membrane filtration module or device 30 is located within the membrane tank 22 above the lower extremity of vertical wall 25.

In use, gas is provided under pressure to the gas collection chamber 23 through port 29 resulting in the level of feed liquid within the chamber 23 being lowered until it reaches the lower end 31 of wall 25. At this stage, the gas escapes rapidly past the wall 25 from compartment 27 and rises through the membrane tank 22 as gas bubbles producing a two-phase gas/liquid flow through the membrane module 30. In other embodiments a gas slug is produced instead of, or in addition to a two-phase gas/liquid flow through the membrane module 30. The surge of gas also produces a rapid reduction of gas within compartment 28 of the gas collection chamber 23 resulting in further feed liquid being siphoned from the bioreactor tank 21 and into the membrane tank 22. The flow of gas through port 29 may be controlled by a valve (not shown) connected to a source of gas (not shown). The valve may be operated by a controller device such as controller 100 discussed above.

It will be appreciated the pulsed gas flow and/or gas slug generating device described in the embodiments above may be used as or in conjunction with a cleaning apparatus in a variety of known membrane configurations and is not limited to the particular arrangements shown. The gas slug generator device may be directly connected to a membrane module or an assembly of modules. In other embodiments a gap may be provided between a gas slug generator device and a membrane module to which the gas slug generator supplies gas slugs. Gas, typically air, is in some embodiments continuously supplied to the gas slug generator device and a pulsed two-phase gas/liquid flow and/or a series of gas slugs is generated for membrane cleaning and surface refreshment. The pulsed flow is in some embodiments generated through the gas slug generator device using a continuous supply of gas, however, it will be appreciated where a non-continuous supply of gas is used a series of gas slugs and/or a two-phase gas/liquid pulsed flow may also be generated but with a different pattern of pulsing.

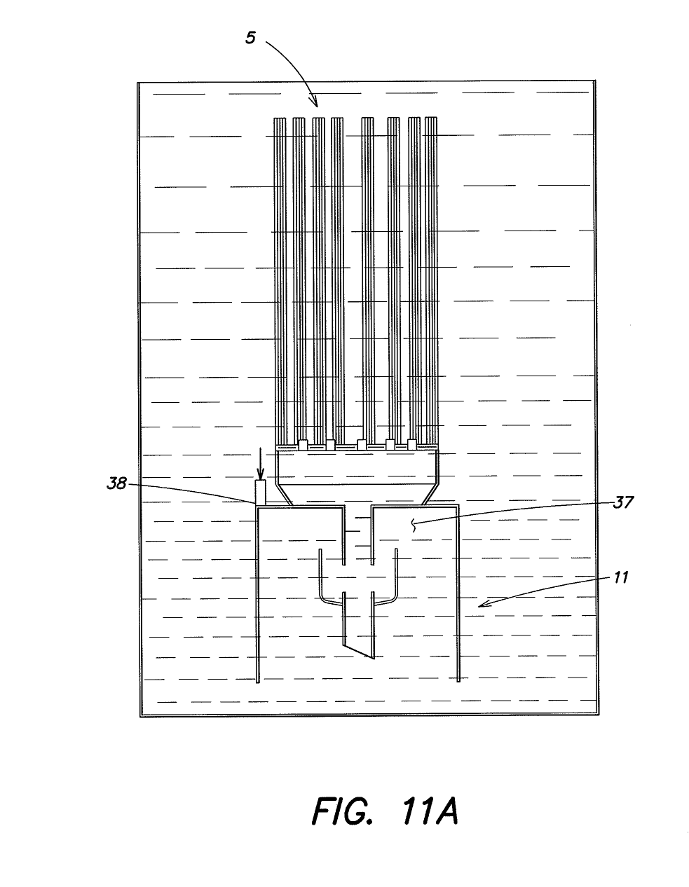

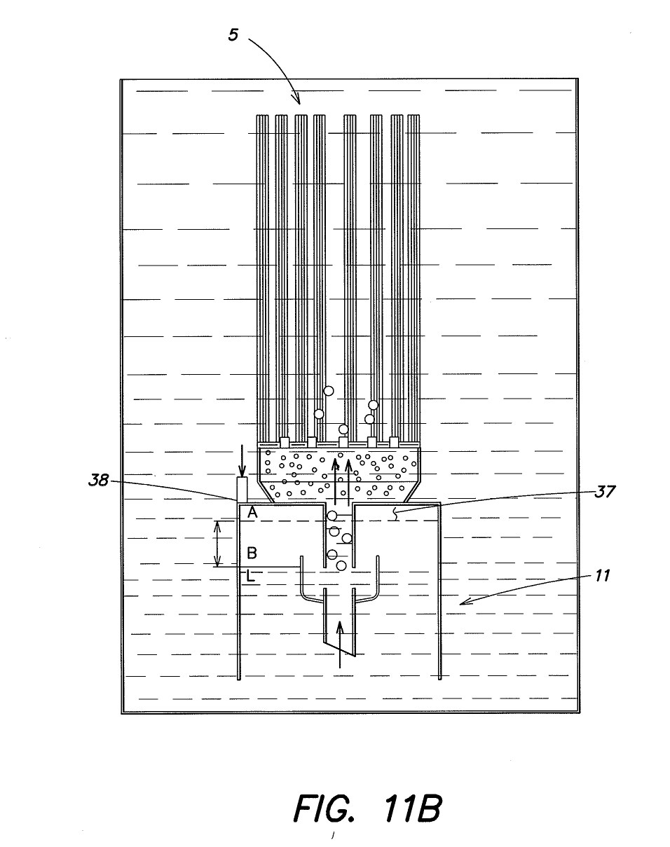

In some applications, it has been found the liquid level inside a gas slug generator device 11 fluctuates between levels A and B as shown in FIGS. 11A and 11B. Near the top end inside the gas slug generator device 11, there may be left a space 37 that liquid phase cannot reach due to gas pocket formation. When such a gas slug generator device 11 is operated in high solid environment, such as in membrane bioreactors, scum and/or dehydrated sludge 39 may gradually accumulate in the space 37 at the top end of the gas slug generator device 11 and this eventually can lead to blockage of the gas flow channel 40, leading to reduced gas slug generation and/or two-phase gas/liquid flow pulsing or no gas slug or pulsed effect at all. FIG. 12 illustrates such a scenario.

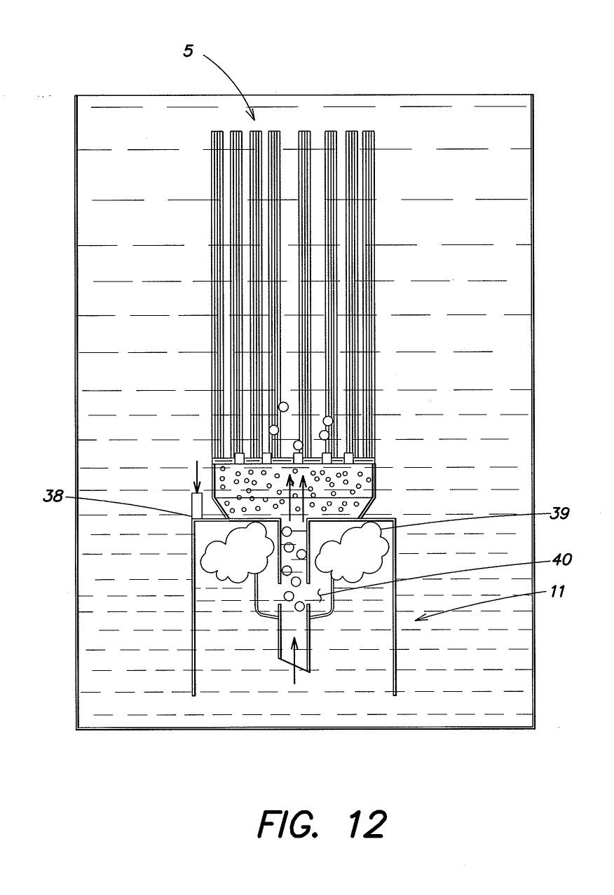

Several methods to overcome this effect have been identified. One method is to locate the gas injection point 38 at a point below the upper liquid level reached during operation, level A in FIGS. 11A and 11B. When the liquid level reaches the gas injection point 38 and above, the gas generates a liquid spray 41 that breaks up possible scum or sludge accumulation near the top end of the gas slug generator device 11. FIG. 13 schematically shows such an action. The intensity of spray 41 is related to the gas injection location 38 and the velocity of gas. This method may prevent any long-term accumulation of sludge inside the gas slug generator device 11.

Another method is to periodically vent gas within the gas slug generator device 11 to allow the liquid level to reach the top end space 37 inside the gas slug generator device 11 during operation. In this case, the injection of gas may be at or near the highest point inside the gas slug generator device 11 so that all or nearly all the gas pocket 37 can be vented. The gas connection point 38 shown in FIG. 11A is an example. Depending on the sludge quality, the venting can be performed periodically at varying frequency to prevent the creation of any permanently dried environment inside the gas slug generator device.

In operation of the gas slug generator device 11 the liquid level A in FIG. 11A can vary according to the gas flowrate. The higher the gas flowrate, the less the gas pocket formation inside the gas slug generator device 11. Accordingly, another method which may be used is to periodically inject a much higher air flow into the gas slug generator device 11 during operation to break up dehydrated sludge. Depending on the design of the device, the gas flowrate required for this action is normally around 30% or more higher than the normal operating gas flowrate. This higher gas flow rate may be achieved in some plant operations by, for example, diverting gas from other membrane tanks to a selected tank to temporarily produce a short, much higher gas flow to break up dehydrated sludge. Alternatively, a standby blower (not shown) can be used periodically to supply more gas flow for a short duration.

The methods described above can be applied individually or in a combined mode to get a long term stable operation and to eliminate any scum/sludge accumulation inside the gas slug generator device 11.

### EXAMPLES

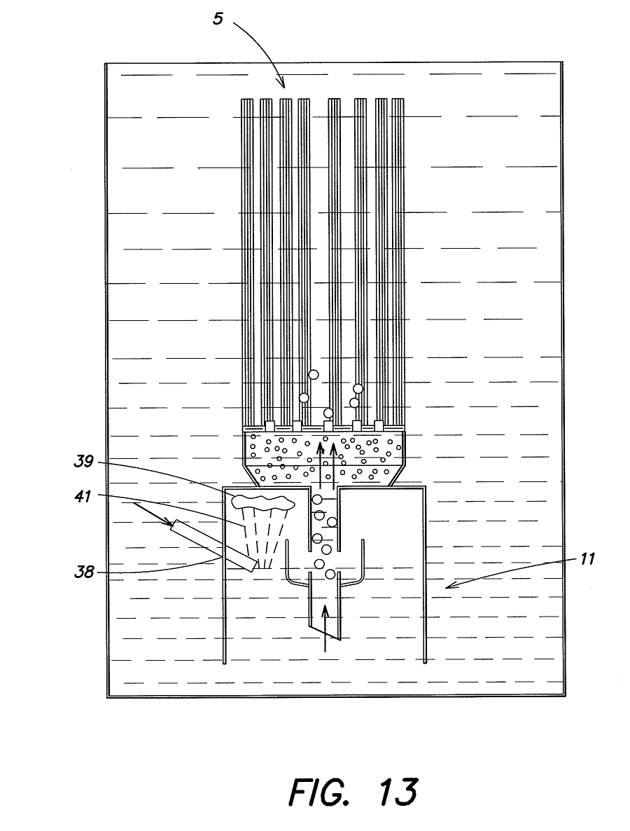

A gas slug generator device was connected to a membrane module composed of hollow fiber membranes, having a total length of 1.6 m and a membrane surface area of 38 m². A paddle wheel flow meter was located at the lower end of the riser tube to monitor the pulsed liquid flow-rate lifted by gas. FIG. 14 shows a snapshot of the pulsed liquid flow-rate at a constant supply of gas flow at 7.8 m³/hr. The snapshot shows that the liquid flow entering the module had a random or chaotic pattern between highs and lows. The frequency from low to high liquid flow-rates was in the range of about 1 to 4.5 seconds. The actual gas flow rate released to the module was not measured because it was mixed with liquid, but the flow pattern was expected to be similar to the liquid flow—ranging between highs and lows in a chaotic nature.

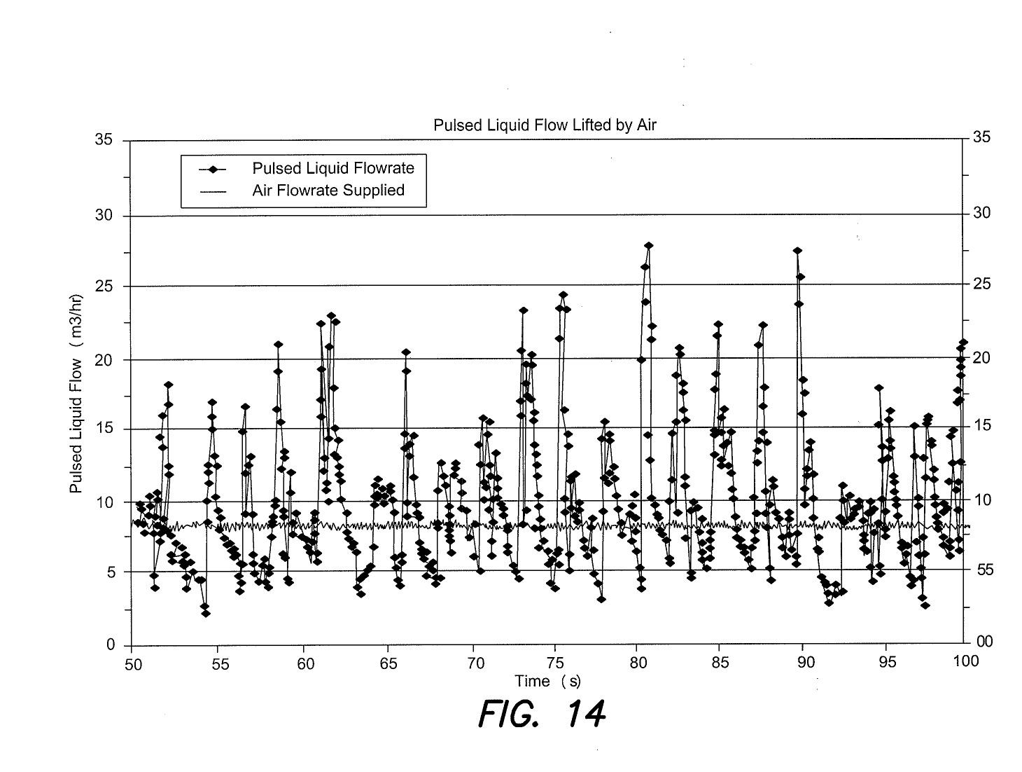

A comparison of membrane cleaning effect via the gas slug generator and normal airlift devices was conducted in a membrane bioreactor. The membrane filtration cycle was 12 minutes filtration followed by one minute relaxation. At each of the air flow rates, two repeated cycles were tested. The only difference between the two sets of tests was the device connected to the module—a normal gas lift device versus a gas slug generator device. The membrane cleaning efficiency was evaluated according to the permeability decline during the filtration. FIG. 15 shows the permeability profiles with the two different devices at different air flow-rates. It is apparent from these graphs that the membrane fouling rate is less with the gas slug generator device because it provides more stable permeability over time than the normal gaslift pump.

A further comparison was performed between the performance of a typical cyclic aeration arrangement and the gas slug generator of the present invention. The airflow rate was 3 m³/h for the gas slug generator, and 6 m³/h for the cyclic aeration. Cyclic aeration periods of 10 seconds on/10 seconds off and 3 seconds on/3 seconds off were tested. The cyclic aeration of 10 seconds on/10 seconds off was chosen to mimic the actual operation of a large scale plant, with the fastest opening and closing of valves being 10 seconds. The cyclic aeration of 3 seconds on/3 seconds off was chosen to mimic a frequency in the range of the operation of the gas slug generator device. The performance was tested at a normalised flux of approximately 30 lmh, and included long filtration cycles of 30 minutes.

Table 1 below summarises the test results on both pulsed airlift operation and two different frequency cyclic aeration operations. The permeability drop during short filtration and long filtration cycles with pulsed airlift operation was much less significant compared to cyclic aeration operation. Although high frequency cyclic aeration improves the membrane performance slightly, the pulsed airlift operation maintained a more stable membrane permeability, confirming a more effective cleaning process with the pulsed airlift arrangement.

TABLE 1
Effect of air scouring mode on membrane performance

| | | 10 s on/ | 3 s on/ |
|---|---|---|---|
| | Pulsed | 10 s off cyclic | 3 s off cyclic |
| Operation mode | airlift | aeration | aeration |
| Membrane permeability | 1.4-2.2 lmh/bar | 3.3-6 lmh/bar | 3.6 lmh/bar |
| drop during 12 minute | | | |
| filtration | | | |
| Membrane permeability | 2.5-4.8 lmh/bar | 10-12 lmh/bar | 7.6 lmh/bar |
| drop during 30 minute | | | |
| filtration | | | |

The above examples demonstrate that an effective membrane cleaning method may be performed with a pulsed flow generating device. With continuous supply of gas to the pulsed flow generating device, a random or chaotic flow pattern is created to effectively clean the membranes. Each cycle pattern of flow is different from the other in duration/frequency, intensity of high and low flows and the flow change profile. Within each cycle, the flow continuously varies from one value to the other in a chaotic fashion.

It will be appreciated that, although the embodiments described above use a series of gas slugs and/or a pulsed gas/liquid flow, the invention is effective when using other randomnly pulsed fluid flows including gas, gas bubbles, and liquid.

Membrane scrubbing accomplished using a gas slug flow and/or a two phase gas/liquid slug flow finds particular application in a membrane bio-reactor (MBR) treatment systems, though it will appreciated that such a slug flow may be used in a variety of applications requiring a gas and/or a two-phase gas/liquid flow to produce a cleaning effect on membranes. As such, embodiments disclosed herein are not limited in application to MBR systems. Similarly, MBR applications often require the use of a gas, typically air, containing oxygen in order to promote biological action within the system whereas other membrane application may use other gas apart from air to provide cleaning. Accordingly, the type of gas used is not narrowly critical.

MBR fluid treatment is a combined process of biological oxidation with membrane separation. This technology has been employed for industrial and domestic wastewater treatment. Compared to some other fluid treatment technologies, MBR has the advantages including smaller footprint, high yield and extra-purity of effluent, higher organic loading and lower sludge production. To further increase productivity and efficiency while maintaining a stable operational performance, the control of concentration polarization and subsequent membrane fouling is desirable. Techniques shown to be effective include turbulence promoters, corrugated membrane surfaces, pulsating flow and vortex generation. However, it has been demonstrated that injecting air bubbles is a cheap and effective way of reducing concentration polarization and thus enhancing the permeate flux in hollow fiber membrane modules. In addition, in the process of a membrane bio-reactor, air bubbles may also be used for another purpose—as oxygen supply.

Depending on the air and liquid flow rates into a gas slug generator and the properties of the liquid, the mixture of air and liquid can adopt a wide spectrum of flow patterns. A number of different flow patterns are illustrated in FIG. 16. In an MBR where the applied air flow rates are relatively low, gas slug flow (also known as plug flow) has been found desirable. In these air-liquid two-phase flow systems, a few mechanisms have been identified to contribute to the flux increase:

a) Experimental investigations on the effect of the hydrodynamic conditions and system configuration on the permeate flux in an MBR system showed that the permeate flux for two phases (air and liquid) cross flow was 20-60% higher than that of single phase (liquid only) cross flow. It is desirable to have higher superficial cross flow because at higher velocity magnitude, the activated sludge can be maintained and the membrane surface can be constantly scoured, which subsequently results in a higher filtration rate and a lower risk of membrane fouling.

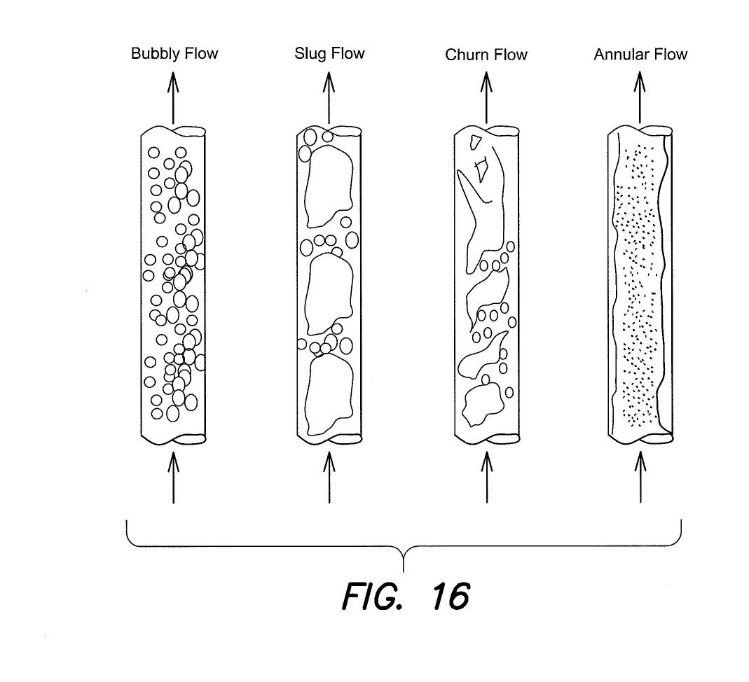

b) Gas slug bubbles generate secondary flows (or wake regions) which assist in breaking up cake layer and subsequently promoting local mixing near the membrane surface. Slug flow, in addition, also produces a stabilized annular liquid film flowing in between the slug and the tube wall as shown in FIG. 17A. The liquid film can be a high shear region promoting mass transfer.

c) Moving slugs result in pulsing pressure in the liquid around the slug, with a higher pressure at its nose and lower pressure at its tail, as best shown in FIG. 17B. This can cause instability and disturbance of the onset of a concentration boundary layer near the membrane surface.

To demonstrate the effectives of slug flow in a MBR system, a study was undertaken using both numerical and experimental investigations to study the hydrodynamic behaviour of a two phases (water-air) MBR system under a slug flow pattern. Particle image velocimetry (PIV) was adopted for experiment and computational fluid dynamics (CFD) was chosen as the numerical tool.

### Experimental Measurement

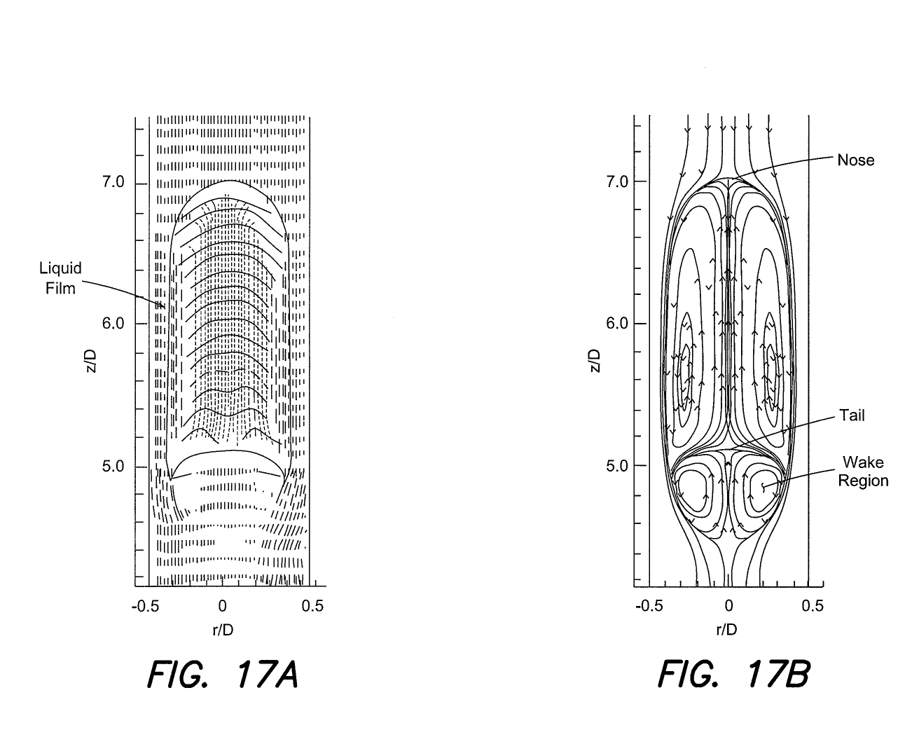

The experimental setup is best shown in FIG. 18. A rectangular tank 50 was constructed out of transparent material. The tank 50 was provided with a water injector 51 at its base and an overflow outlet 52 near it upper end. A fiber membrane module 53 was located within the tank 50. The lower end of the module 53 was provided with a skirt 54 and a gas slug generator 55 constructed according to the embodiment described above. Porous zones 56 were provided in the module to allow fluid flow to and from the module 53. The fibre membranes were potted in potting material 57.

To create the gas slug flow regime, the novel gas slug generator 55 described above was used to generate the two-phase gas/liquid flow. This arrangement was capable of generating air slugs at a well-controlled time interval.

Experimental measurements were conducted using the test setup shown in FIG. 18; one set of which is the flow field measurement using PIV and the other set of which is air bubble size distribution and their trajectories measured by high speed camera. The former measurement was carried out in order to provide reliable and accurate flow data for CFD model refinement while the latter served as an input parameter for CFD modelling.

A typical PIV experimental setup was used, which comprised of a CCD camera and a high power laser. A double pulsed laser was used to illuminate a light sheet across the flow. At the same time, the flow field was seeded with particles to scatter the laser light and work as tracking points. A CCD camera that could take two frames in quick successions was placed orthogonal to the plane of the light sheet. During measurement, which took place through the side window of the test device, the first pulse from the laser illuminated the flow and the light scattered from the particles is captured as the first frame by the camera. After a controlled time interval, the second pulse of the laser again illuminated the flow. The light scattered by the particles was captured as the second frame by the camera. The displacement that individual particles traveled was calculated from the two captured frames. Knowing the time between exposures of the camera, the flow velocity was then evaluated.

For measuring the sizes of air bubbles, a high speed camera was employed. This camera has 17 μm pixels and is capable of capturing up to 250,000 frames per second at reduced resolution.

### Numerical Modelling

In order to replicate experimental observations, the CFD model integrated a Eulerian multiphase model with porous medium scheme and incorporated the vertically dependent filtration flux measurements. A transient simulation for the slug flow study was performed.

### Model Geometry and Operating Conditions

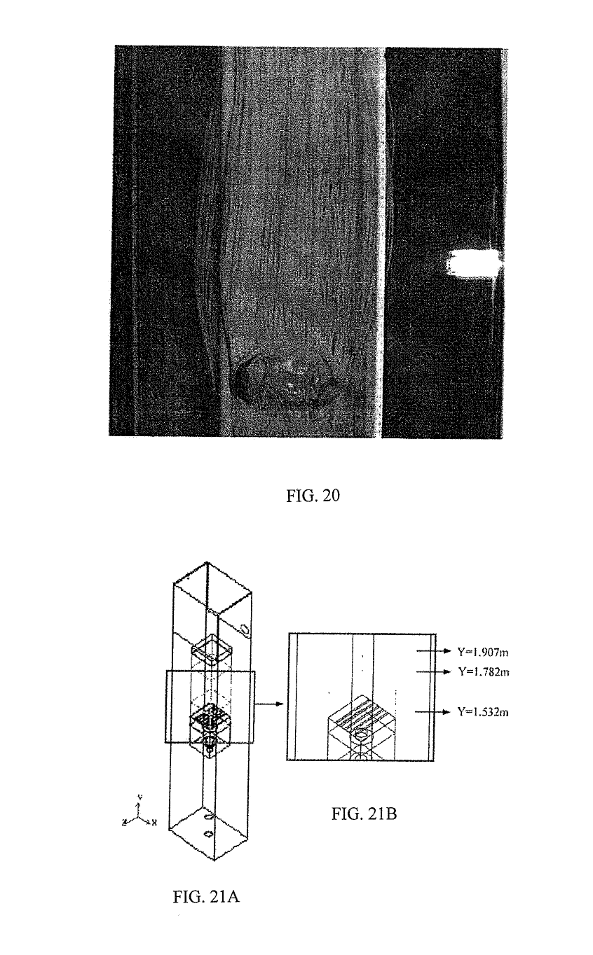

Based on an experimental prototype, the corresponding CFD model geometries were generated, as shown in FIG. 21A. A transient simulation, based on the FIG. 18 model geometry was carried out to replicate the two-phase gas/liquid slug flow phenomena. From the experiment, it is known that under air scouring flow rate of 4 m³/hr, it takes 4.2 seconds to generate one air slug; with 3.8 seconds being the air accumulation stage and 0.4 seconds is the air pulsed stage. To simulate the process of the generation of air slugs, a time dependent step function of mass and momentum source terms were employed in the transient simulation. The mass source has the value of 14.62 kg/m³s and the momentum source is 8.27 N/m³, which were calculated from the operating conditions listed in Table 2. The conditions are the same for both simulation and experiment.

TABLE 2
Operating conditions for both numerical simulation and experiment

| Parameters (Unit) | Slug |
|---|---|
| Fibers packing density (%) | 20 |
| Water circulation flow rate (m³/hr/module) | 2.46 |
| Air scouring flow rate (m³/hr/module) | 4 |
| Filtration flux (l/m²/hr) | 25 |

### Mathematical Equations

In order to simulate the hydraulic distribution within a membrane bio-reactor unit, elements that have significant influences on the hydrodynamics were taken into consideration. The MBR system used in the experiment operated using a slug flow regime and included a membrane separation device in which was provided two phases of state; i.e. water and air bubbles. The membrane separation device includes of a bundle of fibers, which created resistance to the flow circulation. In addition, vacuum pumps were used to generate filtration on the membranes. These features are interdependent and were factored into the CFD model via the incorporation of the following schemes:

i. Eulerian multiphase model is applied to account for the mixing behavior of two phases,
ii. Theoretical model of vertically dependent filtration flux,
iii. Porous medium model to consider the membrane module resistance to water circulation, and
iv. Experimentally measured bubble diameter profile.

### Eulerian Multiphase Model

In the Eulerian multiphase model, a few sets of the coupled basic conservation equations of mass, momentum and turbulence kinetics are applied to simulate the flow field and concentration distributions of water and air.

a. Mass Continuity Equation
Eq. (1) indicates the unsteady mass continuity equation for phase q.

$$\frac{\partial }{\partial t} ( {α}_{q} {ρ}_{q} ) + ∇ \cdot ( {α}_{q} {ρ}_{q} {{V}^{->}}_{q} ) = {\sum }_{p = 1}^{n} ( {\dot{m}}_{pq} - {\dot{m}}_{qp} ) + {S}_{q} \qquad ( 1 )$$

Where t is time (s), α is the volume fraction of fluid, \vec{V_{q}} is the velocity (m/s) of phase q and \dot{m}_{pq} characterizes the mass transfer (kg/s) from phase p to q, \dot{m}_{qp} characterizes the mass transfer from the q^{th} to p^{th} phase and S_{q} is the source or sink term.
b. Momentum Conservation Equation

The unsteady momentum balance for phase q gives

$$\frac{\partial }{\partial t} ( {α}_{q} {ρ}_{q} {{V}^{->}}_{q} ) + ∇ \cdot ( {α}_{q} {ρ}_{q} {{V}^{->}}_{q} {{V}^{->}}_{q} ) = - {α}_{q} ∇ p + ∇ \cdot \overline{\overline{{τ}_{q}}} + {α}_{q} {ρ}_{q} g + {\sum }_{p = 1}^{n} ( \begin{matrix}\vec{{R}_{pq}} + {\dot{m}}_{pq} \vec{{V}_{pq}} - \\ {\dot{m}}_{qp} \vec{{V}_{qp}}\end{matrix} ) \qquad ( 2 )$$

where τ̅_̅{̅q̅}̅ is the q^{th} phase stress-strain tensor (Pa) (see eq. (3)), \vec{R_{pq}} is an interaction force between phases, p is the pressure (Pa) shared by all phases, g is gravity (m²/s), and \vec{V_{pq}} is the inter-phase velocity.

$$\overline{\overline{{τ}_{q}}} = {α}_{q} {μ}_{q} ( ∇ {{V}^{->}}_{q} + ∇ {{V}^{->}}_{q}^{T} ) + {α}_{q} ( {λ}_{q} - \frac{2}{3} {μ}_{q} ) ∇ \cdot \vec{{V}_{q}} {I}^{\overline{\_}} \qquad ( 3 )$$

Here μ_{q} and λ_{q} are the shear and bulk viscosity (kg/ms) of phase q, respectively.
c. Realizable κ-ε Mixture Turbulence Model

The κ (Turbulent kinetic energy per unit mass (m²/s²)) and ε (Turbulent kinetic energy dissipation rate (m²/s³)) equations describing the realizable κ-ε mixture turbulence model are as follows:

$$\begin{matrix}\frac{\partial }{\partial t} ( {ρ}_{m} κ ) + ∇ \cdot ( {ρ}_{m} \vec{{V}_{m}} κ ) = ∇ \cdot ( \frac{{μ}_{t , m}}{{σ}_{k}} ∇ κ ) + {G}_{k , m} + {G}_{b , m} - {ρ}_{m} ɛ & ( 4 ) \\ \frac{\partial }{\partial t} ( {ρ}_{m} ɛ ) + ∇ \cdot ( {ρ}_{m} \vec{{V}_{m}} ɛ ) = ∇ \cdot ( \frac{{μ}_{t , m}}{{σ}_{ɛ}} ∇ ɛ ) + {ρ}_{m} {C}_{1 , m} {S}_{m} {ɛ}_{b , m} - {ρ}_{m} {C}_{2} \frac{{ɛ}^{2}}{κ + \sqrt{{v}_{m} ɛ}} + {C}_{1 ɛ} \frac{ɛ}{κ} {C}_{3 ɛ , m} G & ( 5 )\end{matrix}$$

Here G_{b,m} is the generation of turbulence kinetic energy due to buoyancy, G_{k,m} is the generation of turbulence kinetic energy due to the mean velocity gradients, and v is kinematic viscosity (m²/s).
The mixture density and velocity, ρₘ (kg/m³) and \vec{Vₘ}, are computed from

$${ρ}_{m} = {\sum }_{i = 1}^{N} {α}_{i} {ρ}_{i} ; \vec{{V}_{m}} = \frac{{\sum }_{i = 1}^{N} {α}_{i} {ρ}_{i} \vec{{V}_{i}}}{{\sum }_{i = 1}^{N} {α}_{i} {ρ}_{i}}$$

and the turbulent viscosity, μ_{t,m} is computed from

$${μ}_{t , m} = {ρ}_{m} {C}_{μ} \frac{{κ}^{2}}{ɛ}$$

In these equations, C₂ and C_{1ε} are constants and σ_{κ} and σ_{ε} are the turbulent Prandtl numbers for κ and ε, respectively.

### Vertically Dependent Filtration Flux

In the experiment where the suction pump is on, because of the pressure drop while permeate flux travels in the fiber lumens, the filtration flux is vertically dependent; with higher trans-membrane pressure at the top of the fibers and lower trans-membrane pressure at the bottom of the fibers. In order to reflect this phenomenon, a vertical filtration flux is calculated from the pressure difference across the fiber. Eq. (6) shows a vertically dependent filtration flux.

Filtration Flux=0.0046*H*H−0.0012*H+0.013 (6)

where filtration flux is in the unit of kg/s and H is height in meters. The vertically dependent filtration flux is included as volumetric mass sink, S_{q} of eq. (1). This mass sink is added in the porous region to represent the vertically dependent filtration flux along the fibers.

### Porous Medium Model

The porous medium model incorporates flow resistances in a region of the model defined as porous zone (see FIGS. 21A and 21B). In other words, the porous medium model applies an additional volume-based momentum sink in the governing momentum equations to simulate the pressure loss through a porous region. In this study, the following model is used to represent the flow resistances.

$${S}_{i} = - ( {\sum }_{j = 1}^{3} {D}_{ij} μ {V}_{j} + {\sum }_{j = 1}^{3} \frac{{K}_{ij}}{2} ρ {V}_{mag} {V}_{j} ) \qquad ( 7 )$$

where Sᵢ is the source term for the i^{th} (x, y or z) momentum equation and D and K are prescribed matrices. The first term in eq. (7) represents viscosity-dominated loss and the second term is an inertia loss term. These resistances are calculated based on the tube bank assumption which is similar to fiber bundle used in MBR.

### Experimentally Measured Bubble Diameter Profile

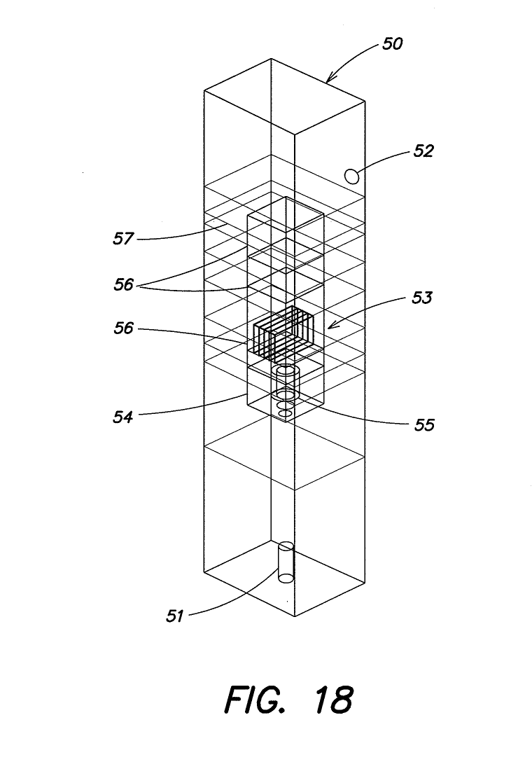

For a better comparison between experiment and simulation, a variable bubble size was applied. The bubble size profile was determined from the high speed camera experiment, as shown in FIG. 19. But, due to the limitations of the experiment, for the slug flow regime, the bubble diameter was measured from Y=1.4m to Y=1.8m. Below Y=1.4m, the bubble diameter was assumed as 3 mm and above Y=1.8m, the bubble diameter was assumed as 5 mm.

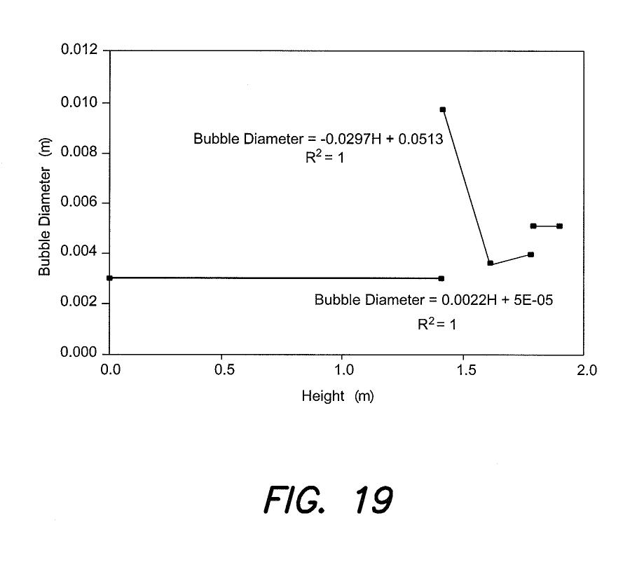

As shown in FIG. 20, a slug flow regime is generated using the aeration device described above. Under this flow regime, both PIV measurement and CFD simulation are conducted and the results are extracted at three different locations along cut-plane 20 mm from glass wall, as shown in FIG. 21B.

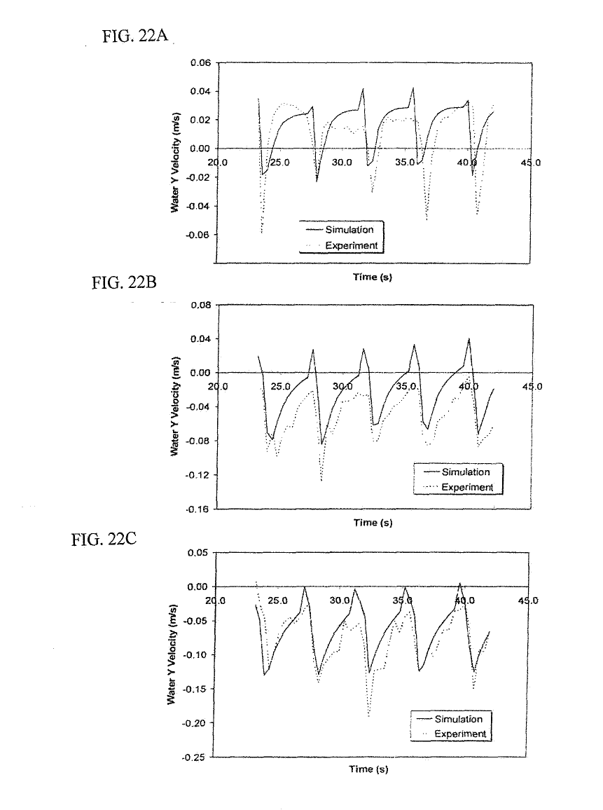

FIGS. 22A to 22C show the comparison between simulated and experimentally measured water Y velocity component at Y=1.532 m, Y=1.782 m and Y=1.907 m along plane 20 mm from the wall, respectively. In FIGS. 22A to 22C, the solid line represents the simulation results and the dotted line stands for experimental measurements. Both experiment and simulation show five cycles of air slug generation. Each cycle illustrates a down-flow velocity followed by an upward velocity for Y=1.532 m and Y=1.782 m. For Y=1.907 m, it is a stronger down-flow velocity followed by a weaker down-flow velocity. In general, within experimental uncertainties and simulation assumptions, the comparison between simulation and experiment at these three locations can be considered as fairly good.

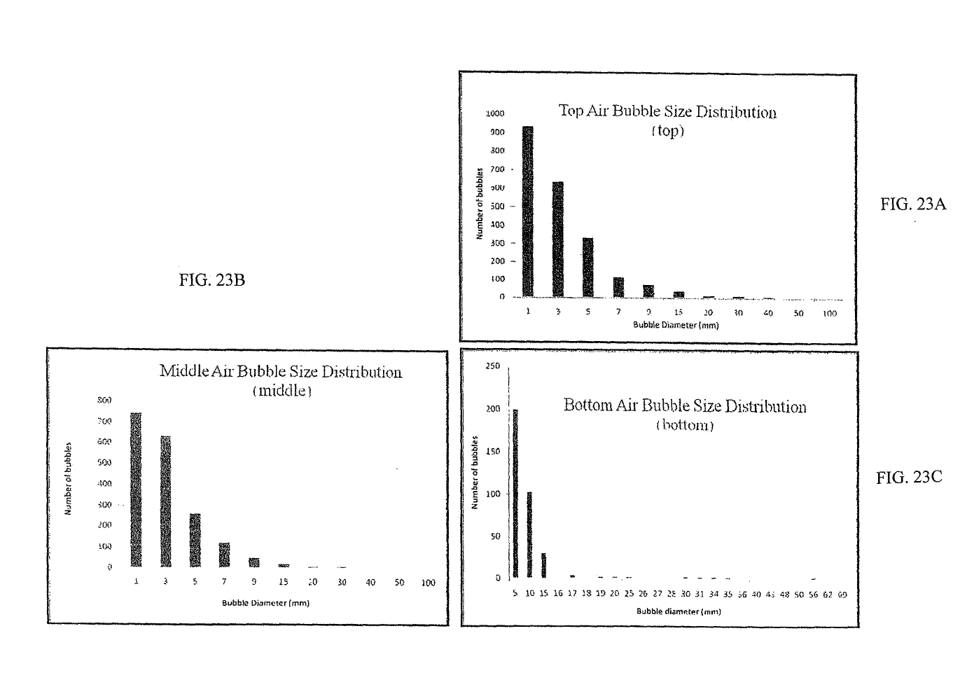

FIGS. 23A to 23C show graphs of the measured air bubble size distribution measured at the top, middle and bottom of the test device during the gas slug generation.

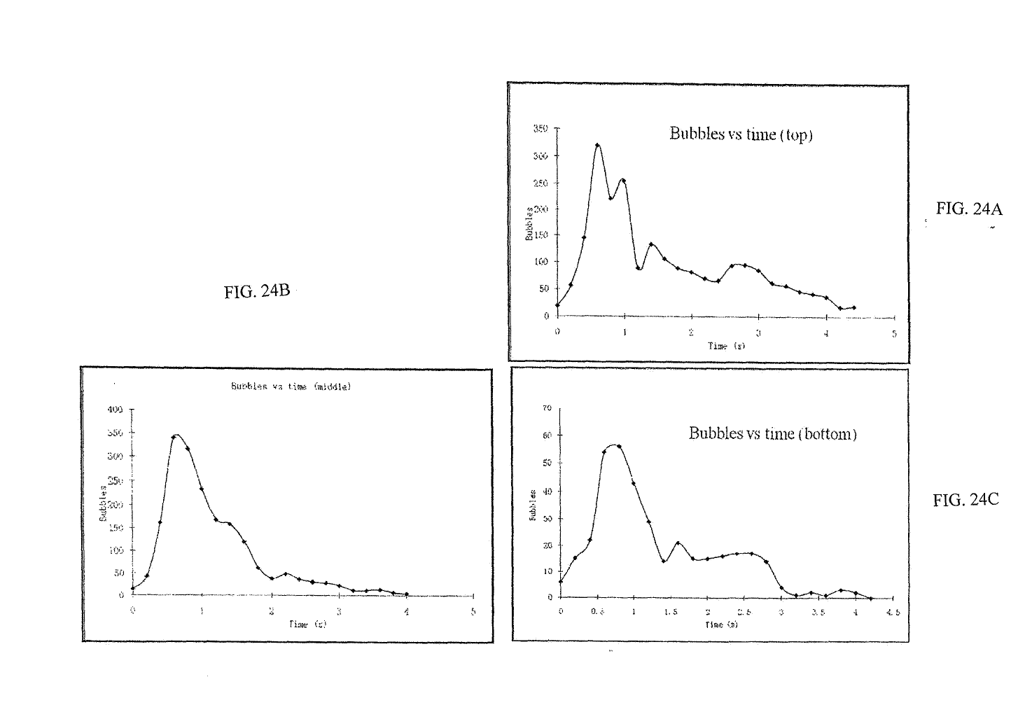

FIGS. 24A to 24C show graphs of the number of bubbles versus time measured at the top, middle and bottom of the test device during the gas slug generation.

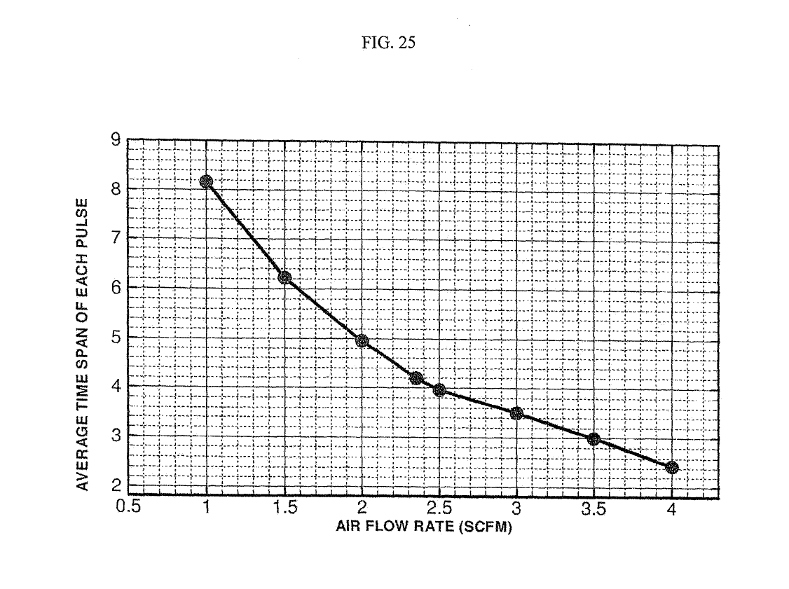

FIG. 25 shows a graph of the average time span of each air/gas slug pulse versus airflow rate.

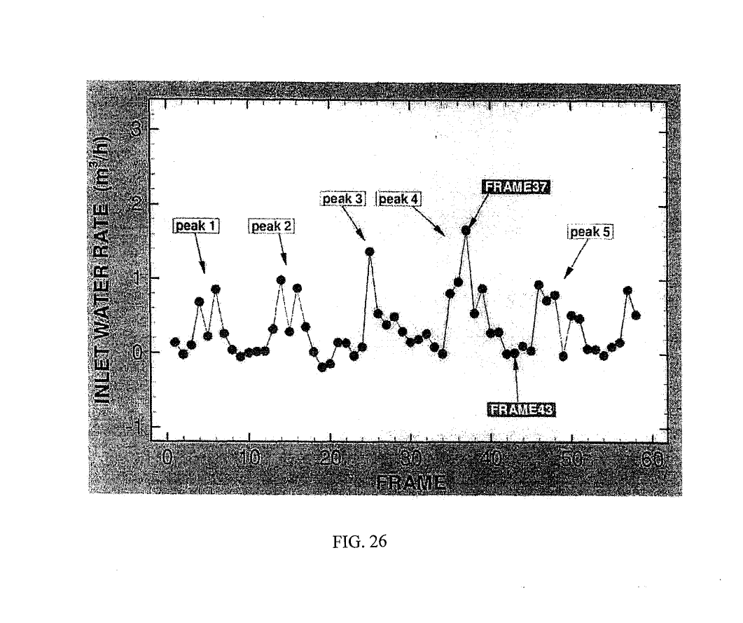

FIG. 26 shows a graph of the pulses on inlet water flow into the aerator generated by the gas slug flow within the aerator. The frames indicate measurements taken by the high speed camera. It can be seen that the inlet water or liquid flow increases rapidly with the generation of the gas slug and then falls again to a lower or zero flow until the next gas slug is produced.

From this study, it is observed from experiment and simulation that operation under a slug flow regime has advantages compared to operation under a bubbly flow regime:

a) Slug flow is a time-dependent process. During the generation of a gas/air slug, the liquid about the membrane fibers exhibits flow instability. This can disturb the concentration boundary layer build up and the accumulation of particles near the membrane surfaces.

b) The flow instability also enhances the oscillation of the fibers. This is desired because the movement of the fibers in a bundle could have a number of effects including collision between fibers that could erode the cake layer on the membrane surface.

c) Slug flow produces a stabilized annular liquid film flowing in between the slug and the tube wall. The liquid film can be a high shear region assisting in wearing away cake layer from the tube wall.

d) Gas/air slugs are larger in size than previously utilized aeration bubbles and thus could generate stronger and longer wake regions, which could disrupt the mass transfer boundary layer and promote local mixing near the membrane surfaces.

e) Operation under slug flow regime requires less air to be supplied than a typical bubbly flow aeration system. For example, in some embodiments, a slug flow aeration system would operate using about 4 m³/hr of gas per module whereas a typical bubbly flow regime which would be operated to produce similar levels of aeration would operate with 7 m³/hr of gas per module. Less gas/air consumption results in lower energy utilization, and thus lower operating costs.

Utilization of a global aeration system as described herein in conjunction with the apparatus described above for providing cleaning of membrane modules with a gas slug flow is expected to provide even further advantages.

Testing has shown that non-uniformity of particle concentration within an entire tank may be significantly reduced using a global circulation system as described herein. The global circulation system establishes up-flow regions are at the membrane module, and in the space between racks, and down-flow regions at the surrounding of the tank. By having a well-controlled flow fields, the particles are more evenly distributed throughout the feed tank.

The increased uniformity of particle distribution within a filtration or feed vessel including filtration modules operating utilizing slug flow membrane cleaning as described above is expected to provide for lower energy operation of a filtration system comprising such a filtration vessel. This is because utilization of global aeration in conjunction with gas slug flow membrane cleaning provides additional redistribution of accumulated solids away from the membrane modules than would be accomplished using gas slug flow cleaning alone. This provides for less gas to be utilized for slug flow cleaning of the membranes to achieve a same amount of membrane cleaning. For example, as described above, in a filtration system utilizing a gas slug flow cleaning mechanism using 4 m³/hr per module, the gas consumption of the gas slug cleaning mechanism is expected to be reducible to 3 m³/hr per module or less if operated in conjunction with a global aeration system. In addition, the removal of solids from the vicinity of the membrane modules would increase the amount of time that the modules could be operated between backwashing or other cleaning operations. By adding a global aeration system to a filtration system operating with gas slug flow membrane cleaning it is expected that energy savings may amount to up to at least about 10% or more versus systems with only gas slug flow membrane cleaning.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention as defined by the appended claims. Accordingly, the foregoing description and drawings are by way of example only.

What is claimed is:

1. A membrane filtration system comprising:
a plurality of membrane modules positioned in a feed tank, at least one of the membrane modules having a gas slug generator positioned below a lower header thereof, the gas slug generator configured and arranged to deliver a gas slug along surfaces of membranes within the at least one of the membrane modules; and
a global aeration system configured to operate independently from an aeration system providing a gas to the gas slug generator, the global aeration system configured and arranged to induce a global circulatory flow of fluid throughout the feed tank.

2. The membrane filtration system of claim 1, further comprising:
a flow rate sensor configured to monitor a flow of permeate from the plurality of membrane modules; and
a controller, in communication with the flow rate sensor, configured to activate the global aeration system responsive to receiving a signal from the flow rate sensor indicative of a flow rate greater than a first amount and configured to deactivate the global aeration system responsive to receiving a signal from the flow rate sensor indicative of a flow rate less than a second amount.

3. The membrane filtration system of claim 2, wherein the plurality of membrane modules are arranged in racks, and wherein the global aeration system comprises gas diffusers configured to deliver gas between the racks of membrane modules.

4. The membrane filtration system of claim 3, wherein the gas diffusers are configured to deliver gas between adjacent membrane modules in a same rack.

5. The membrane filtration system of claim 4, wherein the gas diffusers are configured to deliver gas below the membrane modules.

6. The membrane filtration system of claim 2, wherein the controller is configured to activate the global aeration system when the flow rate is greater than about 25 liters per square meter of filtration membrane surface area per hour.

7. The membrane filtration system of claim 2, wherein the controller is configured to deactivate the global aeration system when the flow rate is less than about 25 liters per square meter of filtration membrane surface area per hour.

8. The membrane filtration system of claim 1, further comprising:
a transmembrane pressure sensor configured to monitor a pressure across the membranes of at least one of the membrane modules; and
a controller, in communication with the transmembrane pressure sensor, configured to activate the global aeration system responsive to receiving a signal from the transmembrane pressure sensor indicative of a transmembrane pressure greater than a first amount and configured to deactivate the global aeration system responsive to receiving a signal from the transmembrane pressure sensor indicative of a transmembrane pressure less than a second amount.

9. The membrane filtration system of claim 1, further comprising:
a feed flow rate sensor configured to monitor a flow rate of feed into the feed tank; and
a controller, in communication with the feed flow rate sensor, configured to activate the global aeration system responsive to receiving a signal from the feed flow rate sensor indicative of a flow rate of feed greater than a first amount and configured to deactivate the global aeration system responsive to receiving a signal from the feed flow rate sensor indicative of a flow rate of feed less than a second amount.

10. The membrane filtration system of claim 1, further comprising a timer configured to activate and deactivate the global aeration system at selected times.

11. A method of filtration comprising:
flowing a liquid medium into a filtration vessel including a plurality of membrane modules positioned therein, each of the membrane modules including an associated gas slug generator positioned below a lower end thereof;
withdrawing permeate from the plurality of membrane modules;
periodically delivering gas slugs from the gas slug generators into the membrane module associated with each gas slug generator, the gas slugs passing along membrane surfaces within each of the membrane modules to dislodge fouling materials therefrom; and
initiating and terminating a global circulatory flow through the filtration vessel responsive to signals derived from at least one of a permeate flow from the membrane modules, a feed flow into the filtration vessel in which the membrane modules are immersed, and a transmembrane pressure across the membranes of at least one of the membrane modules.

12. The method of claim 11, wherein a period of time between the delivery of gas slugs into each of the plurality of membrane modules is randomly determined.

13. The method of claim 12, further comprising providing each gas slug generator with an essentially constant supply of gas.

14. The method of claim 13, wherein initiating the global circulatory flow of feed comprises introducing gas into an aeration system operated independently of the gas slug generators.

15. The method of claim 14, wherein the gas slug generators and the aeration system are supplied with gas from a common source.

16. The method of claim 14, wherein initiating the global circulatory flow of feed further comprises initiating a pulsed flow of gas.

17. The method of claim 11, wherein initiating the global circulatory flow of feed comprises introducing gas between adjacent membrane modules of the plurality of membrane modules.

18. The method of claim 11, wherein the gas slugs are random in volume.

19. The method of claim 11, wherein the timing of the release of gas slugs into a first membrane module is independent of the timing of the release of gas slugs into a second membrane module.
